(19) United States
(12) Patent Application Publication
(10) Pub. No.: US 2025/0335854 A1
(43) Pub. Date: Oct. 30, 2025

(54) SYSTEMS AND METHODS FOR COMPUTER MODELS FOR CLIMATE FINANCIAL RISK MEASUREMENT

(71) Applicant: RISKTHINKING.AI INC., Toronto (CA)

(72) Inventors: Ron Samuel DEMBO, Toronto (CA); John Howard Andrew WIEBE, Toronto (CA)

(21) Appl. No.: 18/275,396

(22) PCT Filed: Feb. 8, 2022
(86) PCT No.: PCT/CA2022/050180

§ 371 Date: Aug. 1, 2023

Related U.S. Application Data
(60) Provisional application No. 63/147,016, filed on Feb. 8, 2021.
(60) Provisional application No. 63/223,917, filed on Jul. 20, 2021.
(60) Provisional application No. 63/271,096, filed on Oct. 22, 2021.

(30) Foreign Application Priority Data
Jun. 1, 2021 (WO) PCT/CA2021/050743

(51) Int. Cl. G06Q 10/0635; G06N 7/01

(52) U.S. Cl. CPC G06Q 10/0635; G06N 7/01

(57) ABSTRACT

Embodiments relate to computer systems and methods for computer models and scenario generation. The system involves generating integrated climate risk data using a Climate Risk Classification Standard hierarchy that maps climate data and multiple risk factors to geographic space and time. A computer model involves risk factors modeled as graphs of nodes, each node corresponding to a risk factor and connected by edges or links. The nodes of the graph create scenario paths for the model. The system automatically generates multifactor scenario sets using the scenario paths for the climate model to compute the likelihood of different scenario paths for the computer model. The scenario sets include transition scenarios.

### CROSS REFERENCE TO RELATED APPLICATIONS

The present application claims priority to U.S. Provisional Patent Application Nos. 63/147,016, 63/223,917, 63/271,096 and International Patent Application No. PCT/CA2021/050743, the entire contents of each of which are hereby incorporated by reference.

### FIELD

The improvements generally relate to the field of computer modelling, classification standards, simulations, scenario generation, risk management, taxonomies, machine learning, and natural language processing. The improvements relate to computer systems that automatically generate scenarios for risk data, and provide visualizations and representations of output for computer interfaces. The computer systems implement automated testing of estimated impacts of scenarios in a scalable, consistent, auditable and reproducible manner.

### INTRODUCTION

Embodiments described herein relate to computer systems for measuring climate financial risk and opportunity. Embodiments described herein relate to computer systems that generate future radical uncertainty measures with data from climate and integrated assessment models, combined with data extracted from scientific research documents. Embodiments described herein relate to computer systems for consistent alignment of historical and forward-looking model-based data across geographies using a computer classification standard or taxonomy. The computer system links transition risk data and physical risk data, for example. Embodiments described herein relate to computer systems for measuring transition exposure, and automatically generating scenarios and computer models for evaluating risk factors consistently and at scale using machine learning, natural language processing, and expert systems. The computer system derives data representing the uncertainty of risk factors in the future. The computer system uses this information as input for scenario generation, testing and computing metrics, and generating interfaces with visual elements for improving visualization of output results.

Embodiments described herein apply to different types of risk factors. Embodiments described herein relate to computer systems with a consistent framework for generating and using scenarios to stress test and calculate risk of an organization under radical uncertainty.

Climate change is an example risk under radical uncertainty. Other example risks are pandemics, cyber risk, and stress testing of financial portfolios.

Embodiments described herein relate to computer systems that generate data structures using classification standards and scenarios for climate and financial risk consistently and at scale, based on the latest climate science, epidemiological science, finance and extracted data elements from expert opinion. The computer system derives data representing the uncertainty of these factors in the future; and uses this information as input for scenario generation.

### SUMMARY

In accordance with an aspect, there is provided a computer system for computer models for risk factors and scenario generation for transition scenarios. The system has a hardware processor with a communication path to the non-transitory memory to store generated transition scenario data and other data computed by system.

In accordance with an aspect, there is provided a computer system for computer models for risk factors and scenario generation. The system has: non-transitory memory storing a risk model comprising a causal graph of nodes for risk factors and a knowledge graph defining an extracted relationship of the nodes, each node storing a quantitative uncertainty value derived for a time horizon, the causal graph having edges connecting the nodes to create scenario paths for the risk model, the knowledge graph of the nodes defining a network structure with links between nodes. The system has a hardware processor with a communication path to the non-transitory memory to: generate integrated risk data structures for a plurality of macro risk factors, wherein the integrated risk data structures map the plurality of macro risk factors to geographic space and time; populate data in the memory by computing values for the plurality of macro risk factors for the time horizon using the integrated climate risk data structures, the values computed by a convolution of micro risk factor distributions to generate distribution measurements for the plurality of macro risk factors; generate multifactor scenario sets using the distribution measurements for the plurality of macro risk factors and the scenario paths for the climate model to compute the likelihood of different scenario paths for the climate model, the multifactor scenario sets representing combinations of the macro risk factors over a time horizon; generate risk metrics using the multifactor scenario sets and the knowledge graph; transmit at least a portion of the risk metrics and the multifactor scenario sets in response to queries by a client application; and store the integrated risk data structures and the multifactor scenario sets in the non-transitory memory; a computer device with a hardware processor having the client application to transmit queries to the hardware processor and an interface to generate visual elements at least in part corresponding to the multifactor scenario sets and the risk metrics received in response to the queries.

In some embodiments, the hardware processor computes the convolution of the micro risk factor distributions using simulations, wherein the micro risk factor distributions correspond to a plurality of micro variables for the macro risk factors.

In some embodiments, the simulation is based on a Monte Carlo simulation.

In some embodiments, each macro risk factor comprises of a set of micro risk factors having corresponding micro risk factor distributions over time, wherein the processor computes a distribution measurement for the respective of macro risk factor using a convolution of the micro risk factor distributions.

In some embodiments, the plurality of macro risk factors comprise a policy macro risk factor, an economy macro risk factor, a carbon macro risk factor, a physical macro risk factor, and a social macro risk factor.

In some embodiments, the interface has a visualization corresponding to a rating for an asset, wherein the visualization depicts a target value and the multifactor distribution of climate stressors on the asset.

In some embodiments, the interface has a visualization depicting climate risk ratings of a financial impact of a stress scenario on an asset.

In some embodiments, the processor generates forward looking uncertainty distributions for each of the macro risk factors, in each geography, at each time horizon.

In some embodiments, the processor generates a transition scenario for a macro risk factor as a selection of the macro risk factor in a given location repeated over each time period or horizon.

In accordance with an aspect, there is provided a computer method for computer models for risk factors and scenario generation to query and aggregate impact, cost, magnitude and probability of risk for different geographic locations. The method involves: storing, in non-transitory memory, a risk model comprising a causal graph of nodes and a knowledge graph defining an extracted relationship of the nodes, each node storing a quantitative uncertainty value derived for the risk factor for a time horizon, the causal graph having edges connecting the nodes to create scenario paths for the risk model, the knowledge graph of the nodes defining a network structure of the risk factors with links between nodes having weight; generating, using a hardware processor with a communication path to the non-transitory memory, integrated, codified and machine-accessible risk data structures for a plurality of macro risk factors, wherein the integrated risk data structures map the plurality of macro risk factors to geographic space and time; populating data in the memory by computing values for the plurality of macro risk factors over the time horizon using the integrated climate risk data structures, the values computed by a convolution of micro risk factor distributions to generate distribution measurements for the plurality of macro risk factors; generating multifactor scenario sets using the distribution measurements for the plurality of macro risk factors and the scenario paths for the climate model to compute the likelihood of different scenario paths for the climate model, the multifactor scenario sets representing combinations of the macro risk factors over a time horizon; generating risk metrics using the multifactor scenario sets and the knowledge graph; transmitting, by the hardware processor, at least a portion of the risk metrics and the multifactor scenario sets in response to queries by a client application; and storing the integrated risk data structures and the multifactor scenario sets in the non-transitory memory.

In some embodiments, the method further comprises generating the convolution of the micro risk factor distributions using simulations, wherein the micro risk factor distributions correspond to a plurality of micro variables for the macro risk factors.

In some embodiments, the method further comprises using a Monte Carlo simulation.

In some embodiments, each macro risk factor comprises of a set of micro risk factors having corresponding micro risk factor distributions over time, wherein the method further involves computing a distribution measurement for the respective of macro risk factor using a convolution of the micro risk factor distributions.

In some embodiments, the plurality of macro risk factors comprise a policy macro risk factor, an economy macro risk factor, a carbon macro risk factor, a physical macro risk factor, and a social macro risk factor.

In some embodiments, the method further involves updating the interface with a visualization corresponding to a rating for an asset, wherein the visualization depicts a target value and the multifactor distribution of climate stressors on the asset.

In some embodiments, the method further involves updating the interface with a visualization depicting climate risk ratings of a financial impact of a stress scenario on an asset.

In some embodiments, the method further involves generating forward looking uncertainty distributions for each of the macro risk factors, in each geography, at each time horizon.

In some embodiments, the method further involves generating a transition scenario for a macro risk factor as a selection of the macro risk factor in a given location repeated over each time period or horizon.

In accordance with an aspect, there is provided a computer method for measuring climate financial risk. The method involves: defining a plurality of macro risk factors, the risk factors comprising different types of risk factors that affect a plurality of assets at each geographic location of a plurality geographic locations, the each of the plurality of assets having a corresponding asset type and geographic location; deriving factor uncertainty at each relevant future horizon, for each asset, in each location, worldwide, wherein the factor uncertainty is expressed as a distribution; evaluating and rating the exposure of the physical asset; generating forward-looking multifactor stress scenarios to stress test each asset at each time horizon; computing a financial impact of all relevant multifactor stress scenarios on the asset; and generating, at an interface on a display device of a computer, visualizations corresponding to the financial impact the relevant multifactor stress scenarios on the asset.

In accordance with an aspect, there is provided a computer system for measuring climate financial risk. The system has non-transitory memory storing a risk model; a hardware processor with a communication path to the non-transitory memory to: define a plurality of macro risk factors, the risk factors comprising different types of risk factors that affect a plurality of assets at each geographic location of a plurality geographic locations, the each of the plurality of assets having a corresponding asset type and geographic location; derive factor uncertainty at each relevant future horizon, for each asset, in each location, worldwide, wherein the factor uncertainty is expressed as a distribution; evaluate and rate the exposure of the physical asset; generate forward-looking multifactor stress scenarios to stress test each asset at each time horizon; compute a financial impact of all relevant multifactor stress scenarios on the asset; and generate, at an interface on a display device of a computer, visualizations corresponding to the financial impact the relevant multifactor stress scenarios on the asset.

In accordance with an aspect, there is provided a non-transitory computer readable medium storing instructions for measuring climate financial risk that involves: defining a plurality of macro risk factors, the risk factors comprising different types of risk factors that affect a plurality of assets at each geographic location of a plurality geographic locations, the each of the plurality of assets having a corresponding asset type and geographic location; deriving factor uncertainty at each relevant future horizon, for each asset, in each location, worldwide, wherein the factor uncertainty is expressed as a distribution; evaluating and rating the exposure of the physical asset; generating forward-looking multifactor stress scenarios to stress test each asset at each time horizon; computing a financial impact of all relevant multifactor stress scenarios on the asset; and generating, at an interface on a display device of a computer, visualizations corresponding to the financial impact the relevant multifactor stress scenarios on the asset.

Many further features and combinations thereof concerning embodiments described herein will appear to those skilled in the art following a reading of the instant disclosure.

### DESCRIPTION OF THE FIGURES

FIG. 1 shows an example visualization of different geographic regions to illustrate the geographical nature of climate change.

FIG. 2 shows an example scenario tree capturing the causal relationship between the risk factors.

FIG. 3 shows an example graph view of uncertainty distributions at the horizon.

FIG. 4 shows an example histogram of possible temperatures.

FIG. 5A shows an example visualization of interface indicating Climate Risk Rating Exposure.

FIG. 5B shows an example of interface indicating Sector Level Exposure for a Climate Rating.

FIG. 5C shows an example visualization of interface indicating Climate Risk Rating Sector Level Exposure.

FIG. 5D shows an example visualization of interface indicating Climate Risk Rating Exposure.

FIG. 5E shows another example visualization of interface indicating Climate Risk Rating Exposure.

FIG. 6 shows a visualization of a mapping of transition scenarios and their relationship to future climate and macroeconomic risk factor uncertainty.

FIG. 7 shows an enlarged region of a visualization of a mapping of transition scenarios.

FIG. 8 shows an enlarged region of a visualization of a mapping of transition scenarios.

FIG. 9 shows an example illustration of system components.

FIG. 10 is a schematic diagram of influence and impacts of the global economic and climate system.

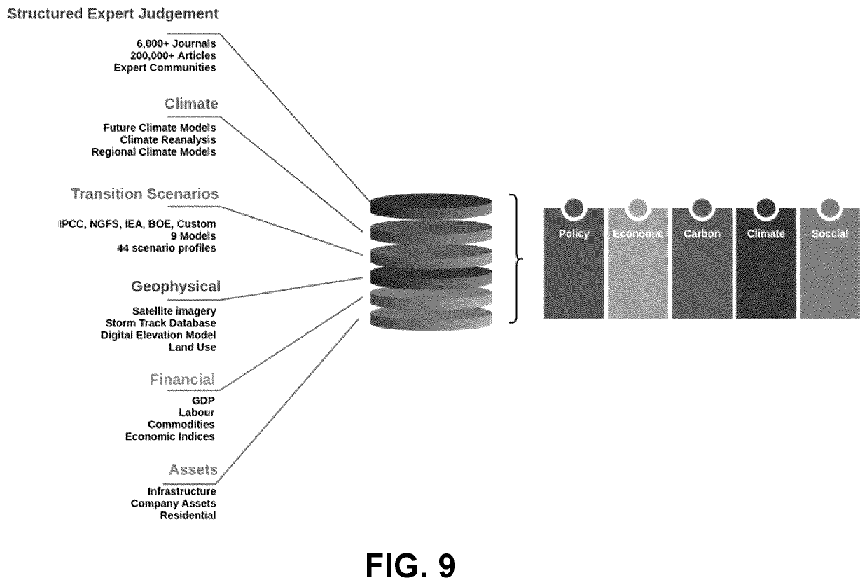

FIG. 9 shows an example interface with a visualization of data for different geographic regions.

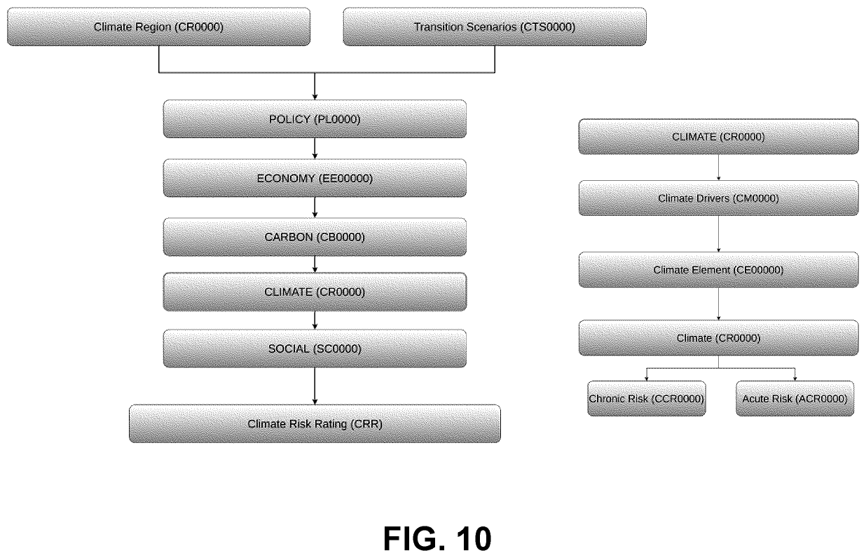

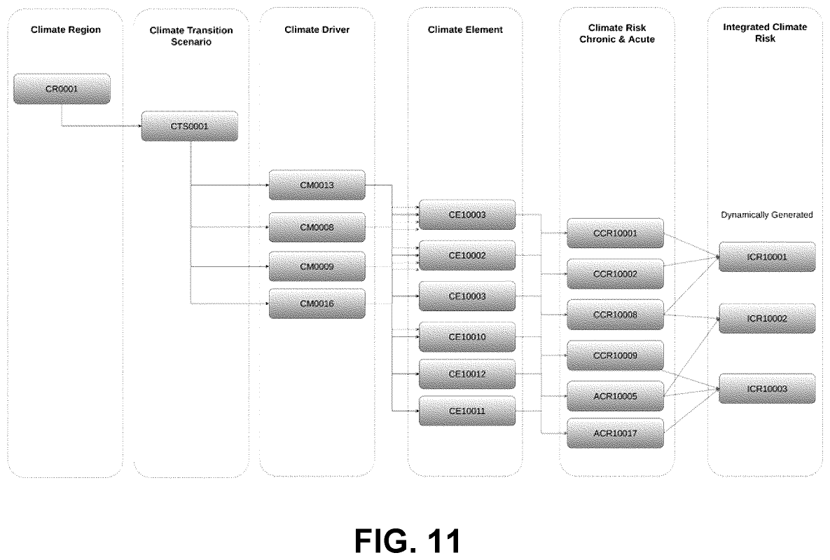

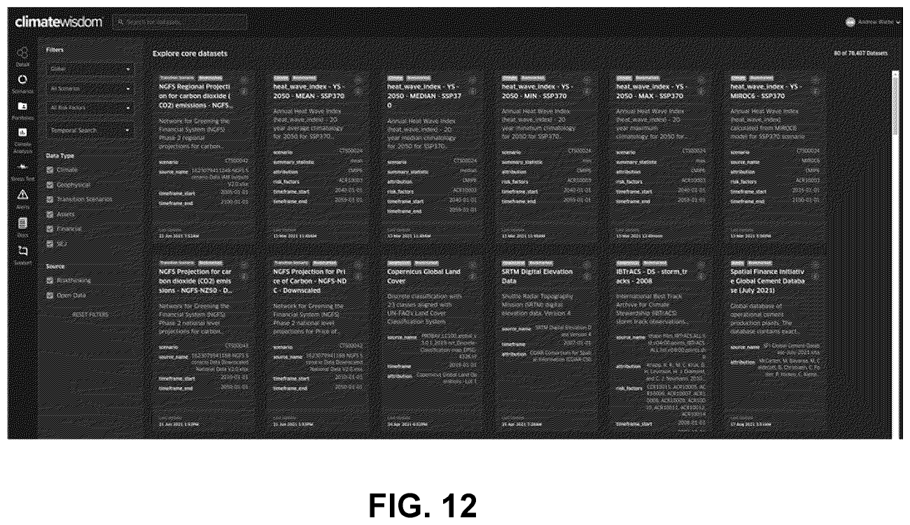

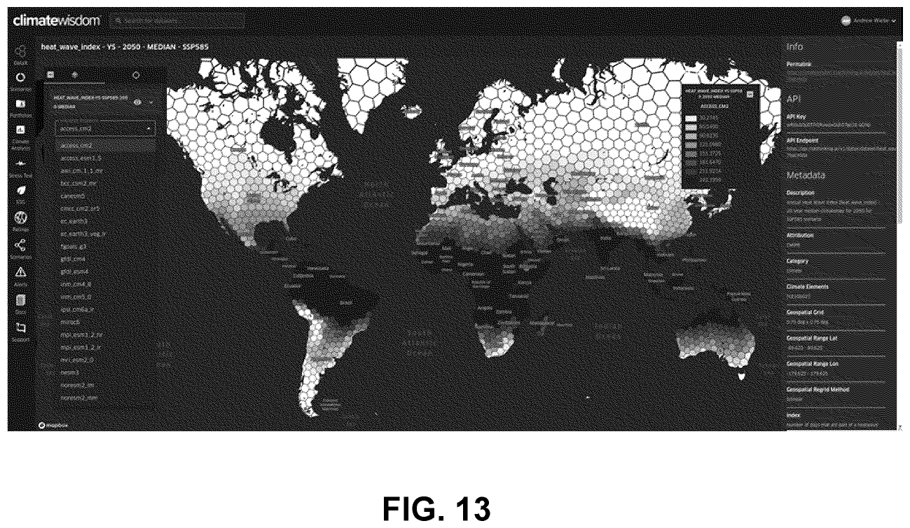

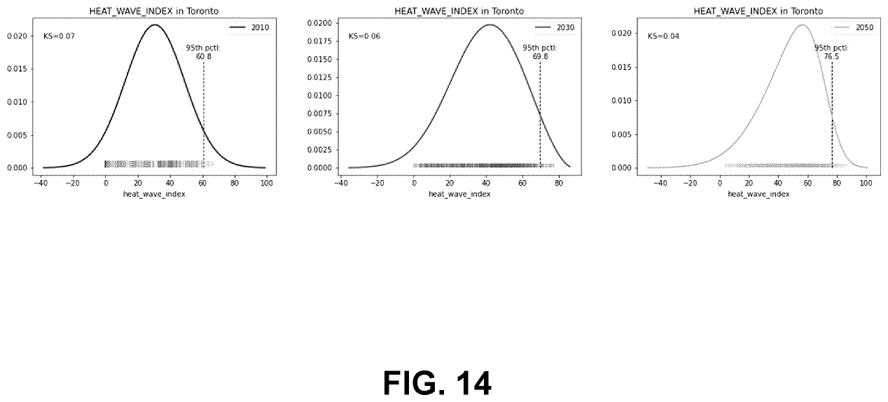

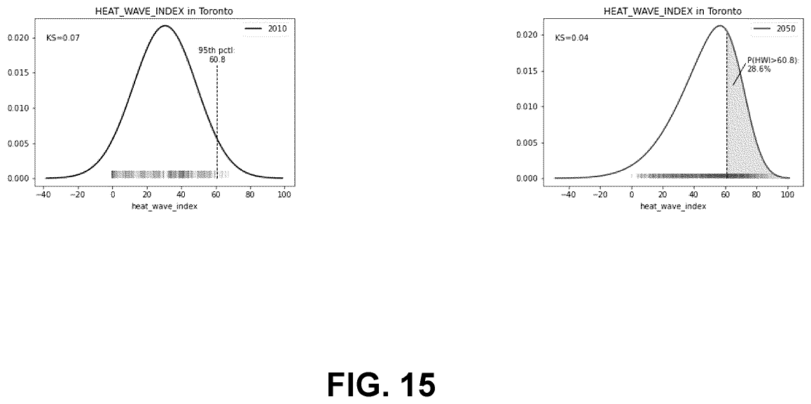

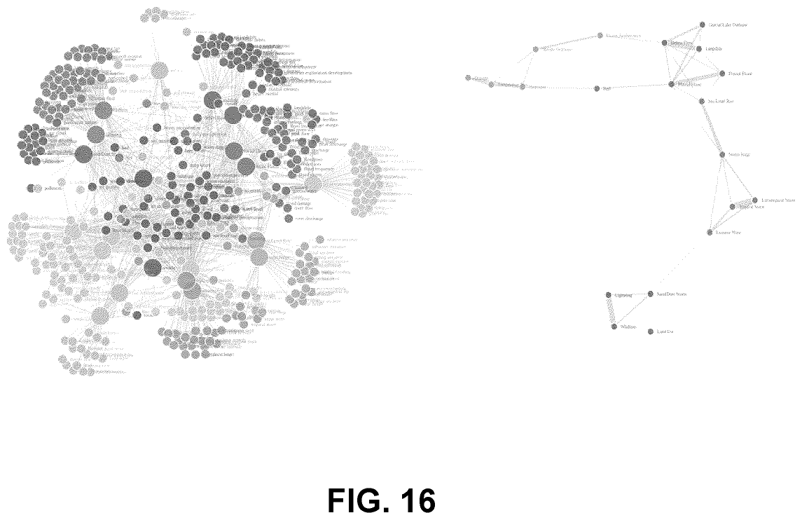

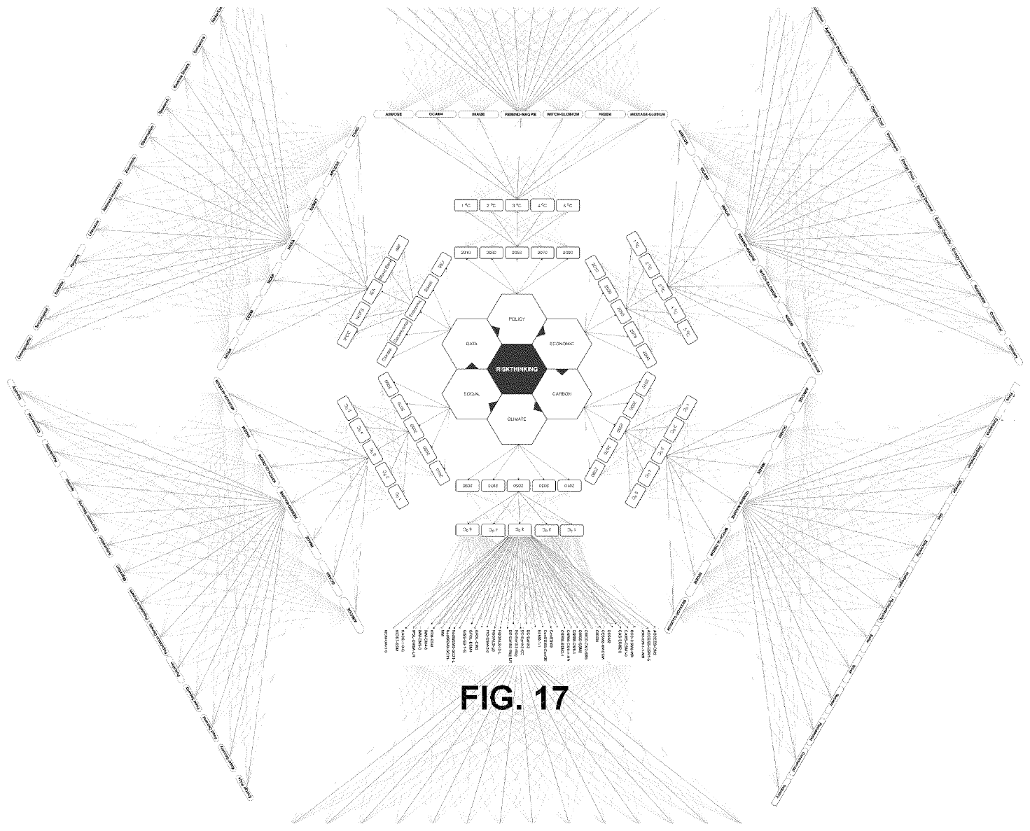

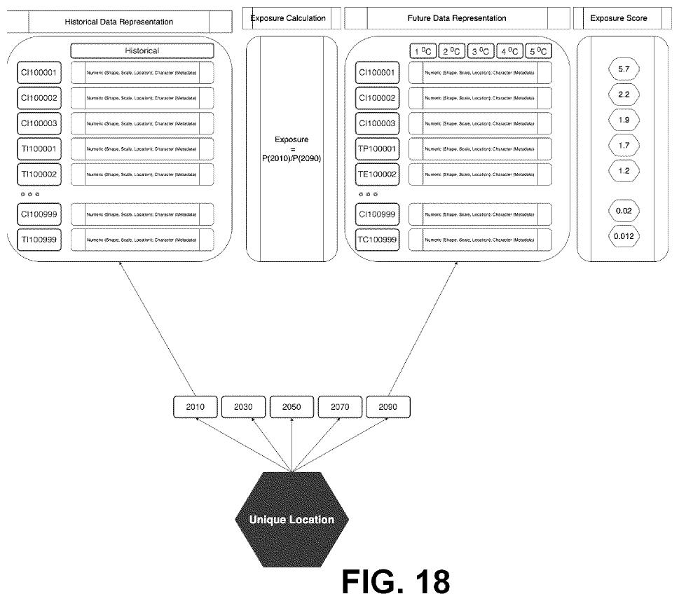

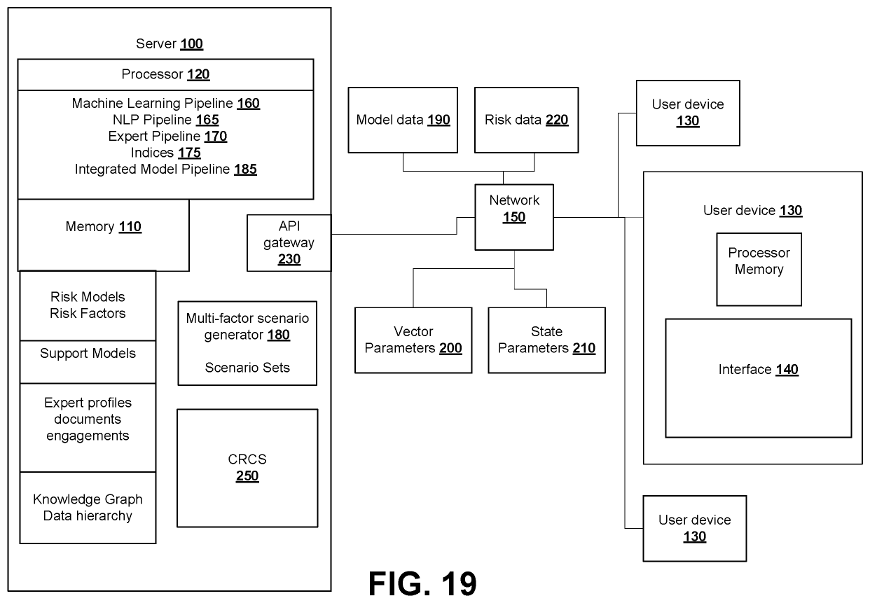

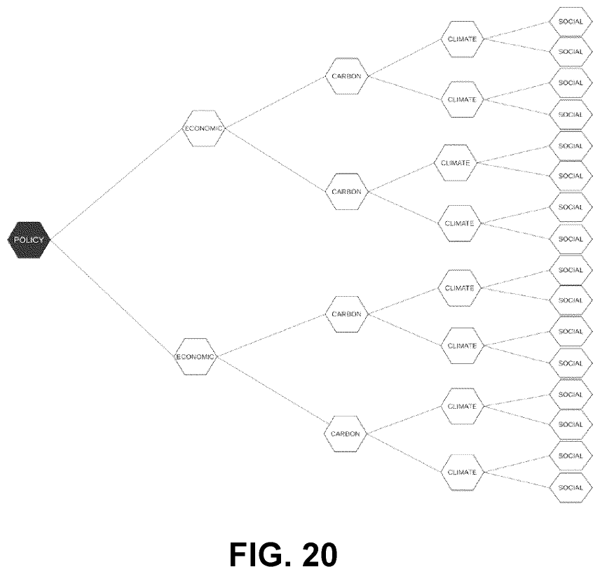

FIG. 10 shows an example illustration of a Climate Risk Classification Standard with climate region data and Transition Scenarios.

FIG. 11 shows an example illustration of climate risk.

FIG. 12 shows an example interface with visualizations for codifying climate data for financial markets.

FIG. 13 shows an example illustration of an interface with output data shown for each hexagon for the geographic region shown.

FIG. 14 shows example distributions for an application for heatwaves.

FIG. 15 shows further example distributions for the application for heatwaves.

FIG. 16 shows an example graph structure for results of natural language processing.

FIG. 17 shows an example illustration of a portion of a complexity matrix.

FIG. 18 shows an example illustration of calculating exposure at a specific location.

FIG. 19 is a view of an example of the system with servers and hardware components.

FIG. 20 is an example scenario tree for risk factors.

### DETAILED DESCRIPTION

Embodiments described herein relate to computer systems for measuring climate financial risk and opportunity. Embodiments described herein relate to computer systems that generate future radical uncertainty measures with data from climate and integrated assessment models, combined with data extracted from scientific research documents. Embodiments described herein relate to computer systems for consistent alignment of historical and forward-looking model-based data across geographies using a classification standard or taxonomy. The computer system links transition risk data and physical risk data, for example. Embodiments described herein provide a computer system to generate integrated climate risk data for computer models and scenario generation. Embodiments described herein provide computer hardware executing instructions to generate scenarios on mixed risk factors. For example, risk factors can relate to climate risk factors. Embodiments described herein provide a computer system to map climate data received from different data sources to different climate regions.

Embodiments described herein relate to computer processes for measuring climate financial risk by linking climate financial risk to the geography in which the asset is located (or asset location), the type of asset being examined, and climate science. For example, two resource or material industrial sites have different climate financial risks depending on their location. In contrast, the risk of a portfolio of financial instruments is the same no matter where the instruments are being measured. The computer processes for measuring climate financial risk can involve the following operations: (i) define or enumerate all risk factors (e.g. risk factors of different types, such as political, environmental, financial) that affect assets at each geographic location, for each relevant asset type, worldwide; (ii) derive factor uncertainty at each relevant future horizon, for each asset, in each location, worldwide, wherein the uncertainty can be expressed as a distribution; (iii) evaluate and rate the exposure of the physical asset (e.g. investment or infrastructure); (iv) generate forward-looking, consistent and relevant multifactor stress scenarios to stress test each asset at each horizon; and (v) compute the financial impact of all relevant multifactor stress scenarios on the asset.

Embodiments described herein relate to a computer classification standard or taxonomy taxonomy for transition scenarios defined by risk factors for measuring transition exposure, risk and opportunity.

Transition scenarios are encoded files defining estimates of future evolution of the world economies and their impact on greenhouse gas emissions. For example, transition regimes are standards used for analyzing future impacts due to climate change. Transition scenarios can be encoded files to link transitions to risk data in a particular geography.

In an aspects, embodiments described herein provide a computer system for quantifying transition risk, i.e. the risk faced during the transition of economies towards a low carbon future. Embodiments described herein provide a computer system that accounts for the stochastic nature of this problem due to radical uncertainty. The economics of the problem is uncertain, how the counterparties that may affect exposure is uncertain and ultimately, the impacts of climate change are uncertain. In the framework of embodiments described herein, transition risks are a consequence the system processing, not an input to it.

Embodiments described herein provide a computer system that can handle transition risk for different institutions. The computer system can provide a comprehensive data platform and output analytics that could be applied across many situations.

The analysis of transition risk can be built upon seven example considerations:

Consistency: The methodology used across markets and sectors within markets needs to be consistent. As an example, if forward-looking scenarios are generated by different groups across the world, they will not be consistent. This can be avoided if there is an acceptable, data-driven scenario system that could be used by different groups. Consistency between transition scenarios and possible scenarios on physical risk is also essential. Embodiments described herein provide a computer system that can generate forward looking scenarios on physical assets conditioned on a set of transition scenarios. Therefore the scenarios on physical assets and the transition scenarios are linked.

Standards/Taxonomy: Standards for the data for climate financial risk measurement, are embodied in a taxonomy of the system. Without standards, data cannot be aligned consistently across different geographic regions. The computer system structures data based on an encoded taxonomy of risk factors and related data elements, which can be referred to herein as a Climate Risk Classification Standard™ (CRCS™). The encoded taxonomy includes data objects, corresponding values, and code executable by a hardware processor to automatically generate output data corresponding to transition exposure.

A computer system can define different elements for automatically evaluating transition exposure, such as:

Radical Uncertainty: Transition risks are radically uncertain and hence a deterministic approach to measuring Transition Risk is bound to fail. The system can account for radical uncertainty and can be stochastic.

Multiple Factors: Climate events are usually the result of multiple climate shocks coming together. An example would be drought, heat and, high winds causing fires.

Climate Science: Climate effects are clearly important and, in particular, the linkage between different geographies that are the result of climate drivers play a significant role. For example, an El Nino event will lead to a series of different, but related climate effects worldwide.

Finance Considerations: The price (or implied price) of commodities and carbon in different locations will differ. So, as opposed to classical financial risk management, the geographic location of an asset makes a difference. For example, an identical steel plant in two different locations across the globe can have different transition risks because the forward-looking factors, be they economic and/or climate, that affect that risk will be different. And geographic locations are linked by the causality of climate drivers.

Transparency and Auditability: Since the outcome has an economic effect on the entity being measured, the data used and methodology for any derived data of the system can be auditable, and all transformations of data, accessible.

Embodiments described herein relate to a consistent framework for measuring climate financial risk that addresses multiple conditions.

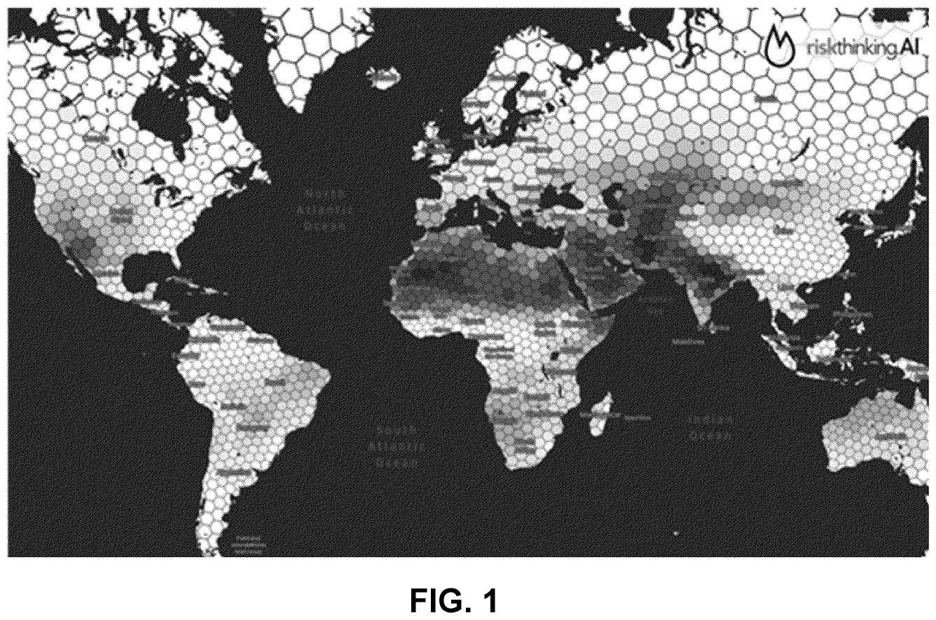

FIG. 1 shows an example visualization of different geographic regions to illustrate the geographical nature of climate change. The visualization depicts the world divided into hexagons (nodes) covering the surface, including the oceans. The hexagons can differ in area depending on the data that is being shown. The visualization illustrates different geographic locations around the world as a set of hexagons on the surface.

For each location (or hexagon of the visualization), the system can collect data for all the factors that are needed to measure risk in that location. For example, there may be a building in the hexagon that has economic value that might be hit by climate stress at some future point in time. For example, FIG. 1 shows the possible heat stress at each location at a particular point in time under a particular climate scenario. Dark red indicates extreme stress and lighter colors less stress.

To calculate climate financial risk, the system captures data available for the hexagon or node or region. For example, if there were multiple buildings dispersed geographically, the system can capture data for each hexagon in which the buildings reside. For a system to measure climate financial risk, the system would need all the data for each hexagon worldwide, including the oceans. The system can represent the future uncertainty in these risk factors. Climate science is uncertain and there is radical uncertainty in the economic and other factors that are at play in that hexagon. In addition, the system can generate multifactor, forward looking scenarios in each hexagon. The system can relate the data of each hexagon or node to other hexagons or nodes since they are linked, not only by the economy in which they reside, but by the effects of climate weather systems that link all the hexagon or nodes across the world.

Climate financial risk and exposure is linked to the geography in which it is being measured. The geographic locations in the world are linked in the way climate drivers affect them.

Embodiments described herein relate to computer systems for consistent alignment of historical and forward-looking model-based data across geographies using a computer classification standard or taxonomy. Embodiments described herein provide a taxonomy and standards for processing and aligning the data consistently worldwide. In every hexagon, for every past and future period, the system can derive data consistently on all the climate and financial factors that affect that particular region. Embodiments described herein use climate science and modelling to derive distributions to capture future uncertainty in those factors. Embodiments described herein use forward-looking, multifactor stress scenarios to stress test physical infrastructure or investment portfolios. Embodiments described herein provide a method for generating multifactor stress tests to maintain consistency across complex supply chains. Embodiments described herein provide improved computerized rating tools and visualizations for computer interfaces.

Embodiments described herein generate distributions of every risk factor, in every location, for every future horizon. The system uses convolutions of distributions of different risk factor variables to generate output for assets. For example, the system can convolute distributions of risk factor variables using simulations (e.g. Monte Carlo simulations). The system can convolute distributions of different risk factor for each of the different assets. The system updates its data by continuously scanning, importing, and extracting data from scientific publications to generate the forward looking distributions for the risk factors. The system can also update or generate data using structured expert pipelines and polling. As new data is added, system can process the new data to align the data with the existing standard or taxonomy. Given the geographic nature of climate change, there is a need for consistency across geographies and the dependence of risk on the asset being stressed. The computer system uses a Climate Risk Classification Standard™ to add new data and align the data with its existing data. Large data sets can be transmitted to system, and then integrated and aligned with its existing data for comparative analysis. To obtain consistency across markets, and sectors within markets, the system can use the process for multi-factor scenario generation. The process receives the individual factor distributions as inputs and produces multifactor scenario as outputs. In this way, the same methodology for multi-factor scenario generation can be used across and within markets for multifactor stress testing of different assets.

Stress scenarios can be conditioned on transition scenarios, since for every transition there could be different relevant stresses. A large ensemble of transition scenarios is needed in all analyses to capture the future (radical) uncertainty of climate change adequately. The system also uses asset data.

Climate risk is stochastic in nature and cannot be solved using deterministic analysis.

The system uses a Climate Risk Classification Standard™ (CRCS™) to align data needed for calculating climate risk exposure anywhere in the world, consistently, based on incorporating the latest climate science and the interlinkages of climate drivers. With this and using multifactor scenario generation, for example, the system can identify assets with extreme exposure that possibly could become stranded. The system can also identify opportunities or scenarios where climate may benefit.

Embodiments described herein provide a comprehensive methodology for measuring transition risks that encapsulates physical and investment risk, that can satisfy the conditions set out above and achieves consistency, which is essential for financial markets.

Regardless of whether the system is measuring Transition Risk, Physical Risk or Investment Risk due to climate change, the system can use a single framework to achieve consistency. An ensemble of transition scenarios is used to derive the future uncertainty of each climate and economic risk factor that is relevant for each region.

Given the future uncertainty of risk factors at different horizons in the future, the system can derive multifactor stress scenarios, using the methodology described, for example, in U.S. Provisional Patent Application Nos. 63/147,016, 63/223,917, 63/217,096 and International Patent Application No. PCT/CA2021/050743, which are incorporated by reference herein. From these stress scenarios, the system can derive an exposure distribution at each horizon for each asset in each geographical location. The system can use convolutions of the distributions using different convolution methods, such as simulation methods, for example. This is applicable to different types of assets. With the distributions, the system can derive an exposure risk rating for all assets at all horizons in all locations. In this way, Physical, Investment and Transition risks are computed consistently.

### Transition Risk

Measuring Transition Risk yields the assets that are severely stressed or significantly advantaged by climate change. By measuring the impact on these assets at risk, the system can ascertain whether an asset is at risk of becoming stranded or likely to do well in a future world.

A physical asset is only stranded if one does not have the capital or the desire to pivot. For example, this has been the case when coal-fired is retrofitted to gas-fired generation. For clarity, the term asset applies to a company/division as a whole or any contained subset of the company. A by-product of this is the cost of avoiding stranded assets.

Given a data environment that meets all the criteria above, the system can provide an analytical framework to measure these exposures costs and benefits. For financial risk measurement, the system can first define the macro risk factors that it will be measuring. The system then has the ability, using input data and derived data, to measure and rate climate stress on assets. The system uses taxonomy of risk factors to structure data.

For any given entity, with assets in different locations, with different risk factors that affect each asset in each location, the system can report and compare multiple assets across multiple geographies using the multi-factor scenarios to guide management of climate risk. The system can use macro risk factors that cover the range of sources of possible financial impacts due to climate change. They are constructed to be mutually exclusive and collectively exhaustive. The factors provide a useful way to express the range of impacts that can be used for measuring risk.

### Macro Risk Factors

The system can use a set of macro risk factors. For example, the system can use five, related macro risk factors:

POLICY(Iₚₒ); ECONOMY(I_{ec}); CARBON(I_{ca}); PHYSICAL(I_{ct}); SOCIAL(Iₛₒ).

The system can use code to define a causal relationship between these macro risk factors, such as for example:

POLICY impacts the ECONOMY, which further impacts the CARBON emitted, which impacts the PHYSICAL (e.g. average temperature rise), which, in turn, affects the impacts on SOCIAL related events.

The Policy Risk Factor score measures the economic and climate future exposure resulting from government or institutional policies. That is, the Policy Risk Factor score measures the risk and possible exposure from the implementation of government or internal policy changes. As such, the system can measure things such as the likelihood of these policies to achieve a particular Global Mean Temperature (GMT) target by 2100 or a Net Zero emissions target, for example. Or, the risks and benefits of various ways move to electric vehicles vs hydrogen powered vehicles in the future.

Governments around the world are establishing new Climate Policies that will change the financial risk profile on assets, industries, sectors, and economies. These policies may align with Shared Socioeconomic Pathways (SSPs) and Integrated Assessment Models (IAMs) that project likely socioeconomic changes into the future. The system can also augment policy data by information extracted from academic papers.

The Economic Exposure Score measures the full distribution of possible impacts from climate change on the economic factors that affect industries, sectors, assets, countries, regions, and markets over time. That is, the Economic Risk Factor Score measures the possible exposure of the world's economies as a result of policy changes that affect industries, sectors, assets, countries, regions, and markets over time. One example source for this data (but not the only one) could be published Transition Scenarios from the Network for Greening the Financial System (NGFS), Intergovernmental Panel on Climate Change (IPCC), International Energy Agency (IEA), and SSPs.

Economic activity, in turn, results in carbon emissions.

The Carbon Exposure Score measures the full distribution of possible exposure on industries, sectors, assets, companies, and economies based on the future implied price of carbon. The Carbon Risk Factor Score can depend on the cumulative output of goods and services in the world's economies, which in turn depend on the policies adopted and their effects on the economies of the world. It also is affected by the implied cost of carbon or the carbon tax if there is one.

The Carbon Risk Factor measures the full distribution of possible risks and impacts on industries, sectors, assets, companies, and economies based on an Implied Carbon Price or the implementation of a Carbon Tax or Emissions Trading System (ETS) within a country or region.

Emission reduction levels can result in an explicit or implicit Carbon price. This price can result in risk exposure for a large number of companies, assets, sectors, industries, countries, and even societies.

As an example, it is projected that the United States will implement a Carbon Price that can impair carbon-related assets or industries in the U.S.

The system can map possible implied Carbon Prices for different countries and regions as projected by NGFS, IPCC, IEA, and European Central Bank, and so on. The system can create a set of Global Mean Temperature aligned Carbon Risk Indices that can be used to calculate the distribution of possible impacts on industries, assets, companies, sectors and even global regions over time. This impact is captured by the system in the form of a Carbon Exposure Risk Score which measures the future financial impact of an implied Carbon Price on assets and markets.

The Physical Exposure Score measures the full distribution of possible exposure of physical and/or investment assets from the increase in Intensity, Frequency and Duration of multiple chronic and acute climate related factors. The Physical Exposure Score can measure climate exposure risk, for example.

The degree of climate-related risk is affected by the amount of carbon emitted which we capture using the factors above. The climate risk factor measures the full distribution of possible impacts on physical assets from the increase in intensity, frequency, and duration of multiple chronic and acute climate-related factors including sea-level rise, wildfires, drought, flooding, heatwave stress, typical cyclones, deforestation, biodiversity loss. These climate risk factors, and the magnitude of each corresponding event that takes place for each factor, can have a direct, measurable financial impact on assets, markets, and regions over time.

The Social Risk Factor Score measures the possible exposure of climate-related change on biodiversity and societies over time. An example way to calculate Social Risk exposure is to create Social Risk Indices that align with global mean temperature projections and incorporate the full distribution of climate-related impacts on social variables (population growth, wildfires, land coverage, food scarcity, litigation, reputation) incorporated within SSPs, and mapped to different regions of the world, for all future periods.

The system computes risk measurements using these factors since they encompass the main drivers of climate change. For instance, Policy, as the policies adopted by countries and corporations will have a big impact on abilities to manage climate change risk. Economy because that is where the production of carbon and the way it is run impacts the climate. Carbon, because it is our key metric for climate change and mitigating or avoiding its usage will have a significant impact on our future climate risk. Physical, because the preceding factors will result in the physical risk to our infrastructure from climate related events. Finally, Social, because climate change will have profound impacts upon people, their desire to migrate, their health and wellbeing and their fight for food and resources. Using these factors, it makes it possible to have comparative scores for two identical assets located in two different geographical locations, and, with some expert judgement data input, does cover possible risk factors that are likely to be encountered.

The macro risk factors are made up of multiple micro risk factors, scattered over many geographical locations that are used to evaluate the impacts of climate stress on a portfolio of assets. For example, the CARBON macro factor maps the many factors that influence the production or mitigation of carbon dioxide equivalents within the atmosphere, such as the future cost of various sequestration methods, the availability and cost of carbon capture and storage, the implied price of carbon, and so on. The POLICY macro factor is made up of the many micro factors that affect an economy, such as edicts to forbid the sale gasoline or diesel powered vehicles by a certain date, the laws requiring 100% renewables in California by 2049, the Danish requirement that all internal flights be made carbon emission free by 2030, and so on. In some cases, the macro factor for POLICY in one country could come from a different country. An example of this might be the policies set in the Unites States could impact the economy of Mexico or Canada, as trading partner.

As noted, there is also a causal relationship which becomes useful for proving computed results relating to the effectiveness of multifactor algorithmic scenario generation. For instance, POLICY affects the economy, which then impacts the production of CARBON, which, in turn, affects the resulting climate PHYSICAL risks, which result in SOCIAL impacts.

The micro risk factors are random variables, and at any point in the future horizon they are represented by uncertainty distributions. The individual macro factors can be represented by uncertainty distributions, which can be derived from the (weighted) convolution of the micro risk factor distributions. Input to the any climate financial risk computation is the future uncertainty of micro risk factors that affect the entity in question, in every geographic location that is relevant to the entity and its physical and investment assets. Deriving these distributions could be done with the judgements of experts on each region. This could be combined with the expert judgements embodied in the transition scenarios that have been developed by the NGFS, IPCC, IEA and others.

The system can define a taxonomy of different variables to define the different macro risk factors. The following table is an example taxonomy of variables for the different macro risk factors.

| Policy | Economic | Carbon | Climate | Social |
|---|---|---|---|---|
| [symbol] ectricity | G [symbol] P | Carbon Seque [symbol] ( [symbol] ss | Sea level rise | Agriculture Price |
| (Capacity [symbol] | | Fossil [symbol] s [symbol] i [symbol] | | non-energy [symbol] pe |
| Demand) | | Processes) | | |
| Gas | C [symbol] Production | Carbon Price ( [symbol] y, | Ocean [symbol] cation | Agriculture Price |
| (Capacity [symbol] | | Residential, | | Livestock |
| Demand) | | Commercial, | | |
| | | Transportation) | | |
| Hydrogen | Steel Production | Carbon Intensity | [symbol] & instability | Agriculture |
| (Capacity [symbol] | | (Industry, | | Production |
| Demand) | | Residential, | | Livestock |
| | | Commercial, | | |
| | | Transportation) | | |
| C [symbol] (Capacity [symbol] | C [symbol] P [symbol] | Energy G [symbol] ion | Ice sheet [symbol] & | Agriculture |
| Demand) | | Carbon Seque [symbol] | instability | Production |
| | | (Electricity, Hydrogen, | | Non-energy crops |
| | | Liquids, Industry) | | |
| [symbol] (Capacity, | Agricultural | Carbon Seque [symbol] | Pe [symbol] | Agriculture |
| Demand) | demand (energy) | (Land Use) | | Demand ( [symbol] |
| | | | | crops, livestock) |
| Biomass | Capital Cost [symbol] | Carbon Seque [symbol] | S [symbol] tion | Consumption |
| (Capacity, | CCS (Biomass, C [symbol] , | (A [symbol] ) | | |
| Demand) | Gas, Geothermal, | | | |
| | Hydro, N [symbol] , Solar, | | | |
| | Wind) | | | |
| Geothermal | Capital Cost [symbol] | Emissions (CH4, | Carbon | Emissions (AFOLU, |
| (Capacity, | CCS (Biomass, C [symbol] , | CO2, F-Gases, Kyoto | emission | Energy, Other) |
| Demand) | Gas, Geothermal, | Gases, N2O, CO, BC, | | |
| | Hydro, N [symbol] , Solar, | HFC, NH3, NO [symbol] , | | |
| | Wind) | [symbol] C, PFC, SF [symbol] , | | |
| | | VOC, 3 [symbol] | | |
| Hydro | Electricity | | [symbol] Temperature | Population |
| (Capacity, | (Investment, | | | |
| Demand) | Price) | | | |
| Solar | Gas (Investment, | | Precipitation | Price (Corn, |
| (Capacity, | Price) | | pattern | Soybean, Wheat) |
| Demand) | | | changes | |
| Wind | Hydrogen | | Biodiversity | Price Residential |
| (Capacity [symbol] | (Investment, | | Loss | Energy |
| Demand) | Price) | | | |
| [symbol] (Capacity, | Coal (Investment, | | Drought | Price Energy |
| Demand) | Price) | | | |
| Residential | Oil (Investment, | | Wildfire | Food Demand |
| (Electricity, | Price) | | | (crops, livestock) |
| Gases, | | | | |
| Liquids, | | | | |
| Hydrogen) | | | | |
| Commercial | Biomass | | Heat wave | Land Co [symbol] (Built-up |
| (Electricity, | (Investment, Price) | | | A [symbol] , Croplands, |
| Gases, | | | | Forest, pasture, |
| Liquids, | | | | Other) |
| Hydrogen) | | | | |
| Industry | Geothermal | | Cold snap | Water [symbol] |
| (Electricity, | (Investment, Price) | | | |
| Gases, | | | | |
| Liquids, | | | | |
| Hydrogen) | | | | |
| Industry | Hydro | | Extreme | Yield (Cereal, |
| (Heat) | (Investment, Price) | | precipitation | [symbol] crops, |
| | | | | Sugarcrops) |
| Residential | Solar (Investment, | | Extreme wind | Fertilizer use |
| (Heat) | Price) | | | |
| Commercial | Wind (Investment, | | Cyclone/ | |
| (Heat) | Price) | | Hurricanes/ | |
| | | | Typhoons | |
| | N [symbol] (Investment, | | Extreme Sea | |
| | Price) | | level (Storm | |
| | | | Surge) | |
| | | | [symbol] | |
| | | | Extra Tropical | |
| | | | Cyclone | |
| | | | C [symbol] ) | |
| | | | Marine | |
| | | | heatwave | |
| | | | Landslides | |
| | | | Dust Storm | |
| | | | Earthquake | |

[symbol]

indicates data missing or illegible when filed

### Multifactor Scenario Generation

To capture how the future might enfold, the system builds a Bayesian Directed Acyclic Network (DAG), the simplest form of which has a binomial scenario tree structure. Paths in this DAG or tree are scenarios made up of all of the risk factors that make up these five macro factors. The paths of the tree capture the multidisciplinary nature of the problem in a comprehensive manner. The chosen macro risk factors are designed to depend on each other in a linear fashion, therefore the use of a DAG (or tree) is appropriate.

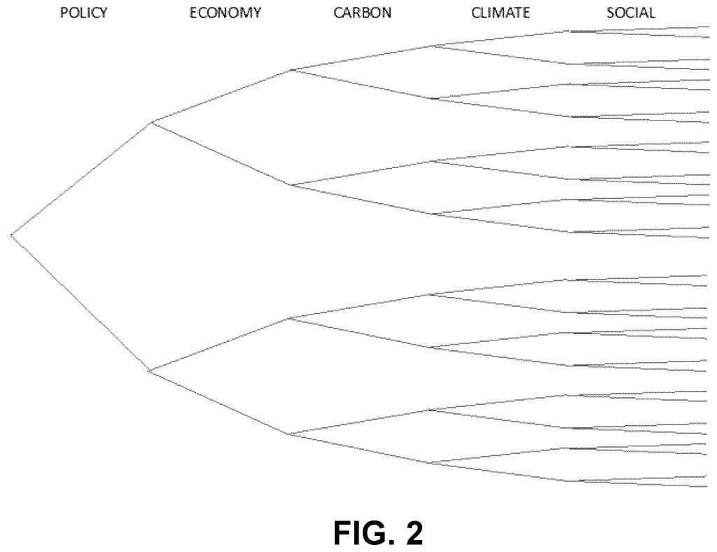

FIG. 2 shows an example multifactor scenario tree capturing the causal relationship between the risk factors Policy, Economy, Carbon, Physical and Social. FIG. 2 shows only a partial view of the tree since, assuming each of the 5 macro factors is derived from 5 factors, the full tree typically has 225 paths (33,554,432 scenarios) for every hexagon shown in FIG. 1.

The multifactor stress scenarios are paths in the tree which are combinations of values for the POLICY, ECONOMY, CARBON, PHYSICAL, SOCIAL, and all the factors from which they are composed. The likelihood of a multifactor scenario is the product of the conditional probabilities along the path. The system obtains these conditional likelihoods derived from the conditional distributions for each of the macro factors.

Numerical values for each of these macro factors are derived from an index that is a particular weighted combination of the micro factors mapped to the Transition scenarios.

One possible embodiment of the system is composed of the five macro factors: Iₚₒ, I_{ec}, I_{ca}, I_{cl}, Iₛₒ.

As an illustrative example:
Iₚₒ=Fₚₒ{Hydrogen, Renewables, No gas cars after 2035, . . . }
I_{ec}=F_{ec}{GDP, LT Interest Rates, Investment in renewables, . . . }
I_{ca}=F_{ca}{Implied carbon price, CCS, Emissions . . . }
I_{cl}=F_{cl}{Sea Level Rise, Heat Wave, Wildfires . . . }
Iₛₒ=Fₛₒ{Cost of Living, Cost of Energy, Food Demand . . . }

In one instance the system contains 2-5 material factors, 5 macro factors each composed of 5 factors for each hexagon. The exposition here is at a much higher level of aggregation for ease of illustration, showing a tree with only five factors. In practice the system can model full complexity. The risk factors reflect the risk of the asset being stressed. For, example, an automobile company the following examples can be considered for Policy Risk: assessing the risk to a strategy for moving from gasoline car production to electric or hydrogen-powered vehicles, the future availability and cost of green hydrogen, the future of renewable generation, the goals set by politicians for ending the production of gasoline-powered vehicles.

The system can generate values for these risk factors using a two-stage process and is influenced by the material factors that affect the transition being studied. For example, the transitions that will affect cement production are different from those that will affect steel. For each sector in the economy, different economic factors influence future risk. That is also true for each geographical location.

A stress scenario is a particular combination of these macro factors (and all the factors from which they are created). A stress scenario can be expressed as:

$$S = f \{ {I}_{po} , {I}_{ec} , {I}_{ca} , {I}_{ci} , {I}_{so} \}$$

The system can generate a spanning set of multi-factor stress scenarios S^{t}={S^{t}₁, S^{t}₂, . . . , S^{t}ₙ} to stress-test the asset at some horizon, t. The system can use forward multifactor scenario generation. For this, input data are the distributions that represent the uncertainty for each risk factor at each horizon and a consensus or target value for the relevant factor, at each horizon.

For example, there may be a 3.2 degree world by 2100. The target value could also be some desired outcome such as a 1.5 degree world, in which case the system is measuring the risks of under or over-achieving the target value.

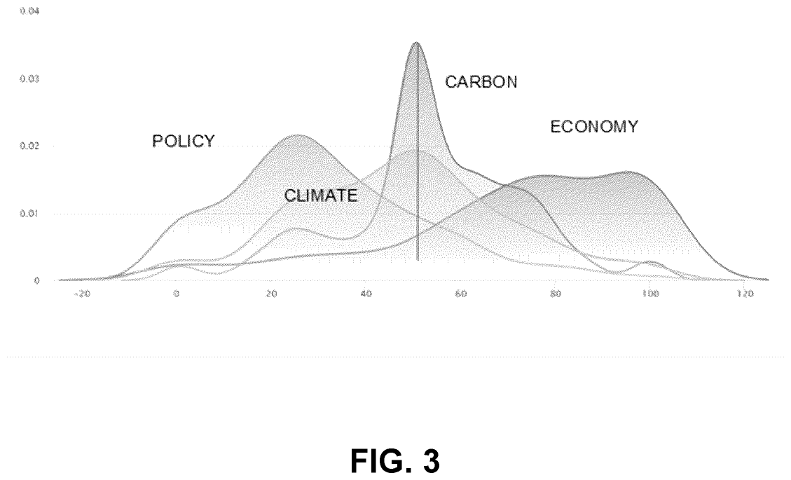

The values for the possible upward and downward possibilities at each node in the tree, and the likelihood of these movements, are generated from the uncertainty distributions (FIG. 3) that are, in turn, derived for each macro factor and based on a set of Transition Scenarios that are designed to span the range of possible paths going forward. In addition, these uncertainty distributions may be augmented by structured expert judgement or polling to gather a wide range of opinions on the uncertainty of factors at future points in time.

FIG. 3 is a graph view of uncertainty distributions at the horizon.

With the consensus value and the distributions, the system can generate the multifactor scenarios to stress test the asset at each future time point. Each macro scenario will have consensus or target values for each of the 5 risk factors, POLICY(I_{PO}), ECONOMIC(I_{EC}), CARBON(I_{CA}), PHYSICAL(I_{CL}) and SOCIAL(I_{SO}).

The exposure to possible Transition Scenarios is dependent on the target or consensus value. For example, a company's exposure to transition will be different depending on the chosen target. Exposure to the Paris 1.5 degree goal for Global Mean Temperature rise is different than exposure to a 2 degree one. As another example, exposure to a carbon tax of $100/ton is not the same as exposure to a $1000/ton tax.

To obtain the overall exposure to the multifactor stresses, the system can compute the multifactor stress scenarios from the scenario tree in FIG. 2. These scenarios are used to understand the Transition exposure or to rate exposure to the example macro risk factors (POLICY, ECONOMY, CARBON, PHYSICAL and SOCIAL).

To value the extreme moves at each node in this tree the system can use the tail values of the distributions that were obtained in FIG. 3. The values for the conditional likelihood of an upward or downward jump are obtained from the positive and negative tails of the uncertainty distributions.

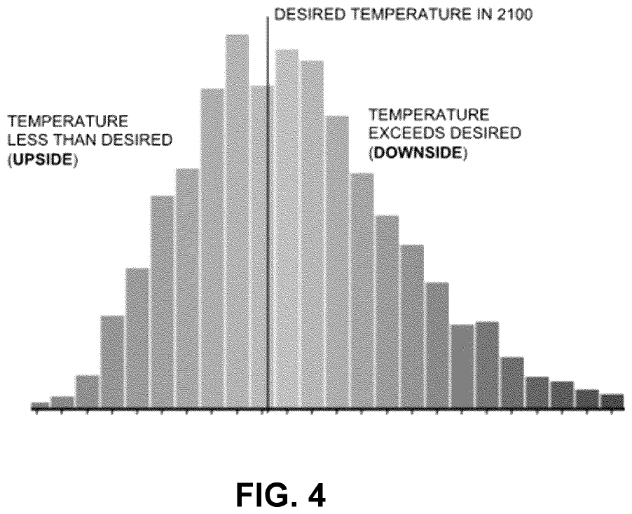

Each scenario path in FIG. 2 has a temperature value. For example, each path can be a deterministic view of the future, which corresponds to a particular carbon profile and resulting world average temperature at the horizon in question. The path also has a likelihood, given by the product of the likelihoods of each conditional likelihood on the path. Therefore, the system can generate a distribution of possible temperatures and their likelihood of occurring, that resembles the distribution in FIG. 4. The consensus value can be the desired world average temperature or some consensus value at that horizon and the area to the right of the desired temperature would be the likelihood of overshoot. The area to the left would be the likelihood of outperformance (i.e. all the scenarios that outperform the desired consensus target).

The graph is FIG. 4 shows an example rating visualization to depict a stochastic analysis of the multifactor climate stresses on an asset.

The system can align to factors that are components of an index other than temperature. For example, using the illustrative indices, the system can align to the implied carbon price in the future. Another way of expressing this is that each path corresponds to an implied carbon price. The set of paths correspond to the distribution of possible implied carbon prices at the chosen horizon. This then enables ratings relative to any of the risk factors that form the components of the indices. This is true for other factors that make up the index.

The stress scenarios, when applied, result in both possible upside and downside.

FIG. 4 is a graph histogram of possible temperatures for 2100 based on current Transitions. The example relates to the overall exposure to a set of Transition Scenarios. This same method can generate a forward-looking distribution on each of the five risk factors using the sub-factors upon which they depend. They could be rated with respect to desired or consensus views on any of the risk factors that are included. Therefore, since the system can effectively generate the full tree for every possible risk factor in each region, the system can measure the Transition exposure for all these risk factors anywhere in the world in a consistent manner. The system provides a solution to a computer technology and massive data problem. There are over 33,897,029,88 hexagons needed to cover the world to a 65 m² resolution. For each hexagon there are 33,554,432 possible combinations of the risk factors that it depends on. This is the result of treating the stochastic nature of this problem. Searching a data space that contains 1,137,395,584,177,540,000 data points for a single point in time may not be computable in an efficient or effective manner. The methodology described above utilises probability theory and binomial tree structures to reduce the search space to an abstract representation of the multitude of distributions. The search space is therefore an exposure of each node (e.g. the upside or downside computation that occurs at each node) in the binomial tree. By searching across the tree for threshold values and limiting the search to geographic regions of interest the computational load is exponentially reduced without any loss of the original data as the parameters of the distribution are retained in memory allowing for the full distribution to be recreated on demand.

The binomial nature of the tree structure allows for only one value to be stored as the representation of the upside/downside. Therefore a search space of 33,554,432 is reduced to 32 bifurcations for the 5 macro risk factors, where each node is the embodiment of the risk potential for each risk factor.

The data is stored in a hierarchical wide column array that is indexed by a spatial and temporal unique identifier. Therefore to retrieve the universe of risk potentials the data structure simply needs to traverse the spatial and temporal dimensions. While large at 33,554,432 by 100 years this is computationally efficient with cloud based architecture and a modem parallel technology stack.

The structure provides a hierarchical methodology to consistently traverse the tree. The hierarchy aligns with the causal nature of the example macro risk factors. No matter which path was take through the tree structure the causal nature of the risk factors is maintained and joint probability computed at the end of the traversal is always valid.

The hexagons are the spatial entity that the data is encoded within. They are the root nodes to every tree.

Exposure can be defined by the magnitude of change from a baseline value. The baseline can be defined as the current accepted level of exposure. For example, Vancouver is currently exposed to an average of 1 extreme heat wave every 20 years. By 2030 the frequency may increase to 1 extreme heat wave every 5 years, a 4-fold increase, under a certain transition scenarios. Other scenarios may see an increase of only 2-fold, other still will show no increase at all. The tails of the distribution may even show a decrease in frequency to 1 in 50 year events or all the way up to an annual occurrence. These are all possible outcomes, although some are more likely than others. The methodology described here quantifies the likelihood of these events, the downside divided by the upside relative to an acceptable risk threshold is the exposure. The integral of this exposure across the spatial and temporal scales is the total exposure presented as the climate risk rating. The exposure can be computed as downside divided by the upside, and the rating is described below.

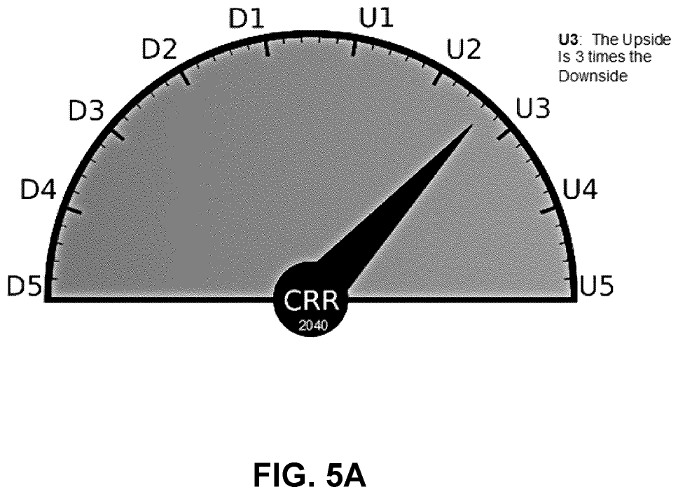

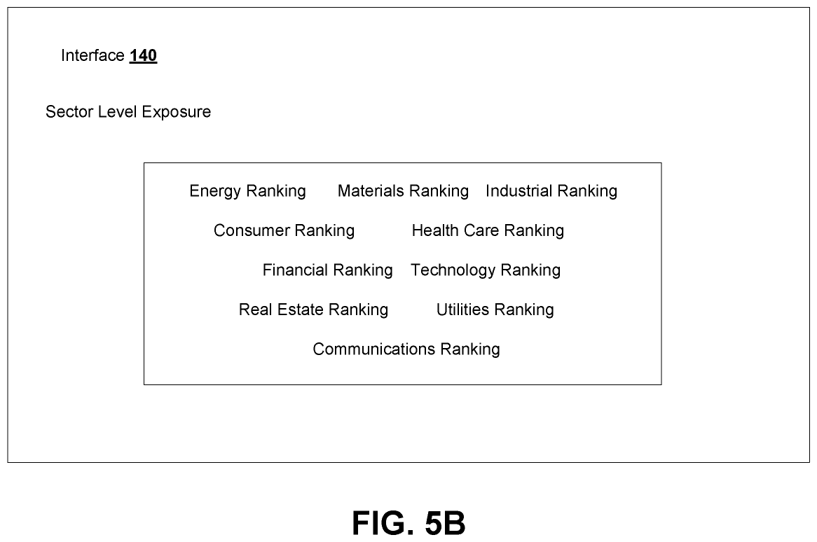

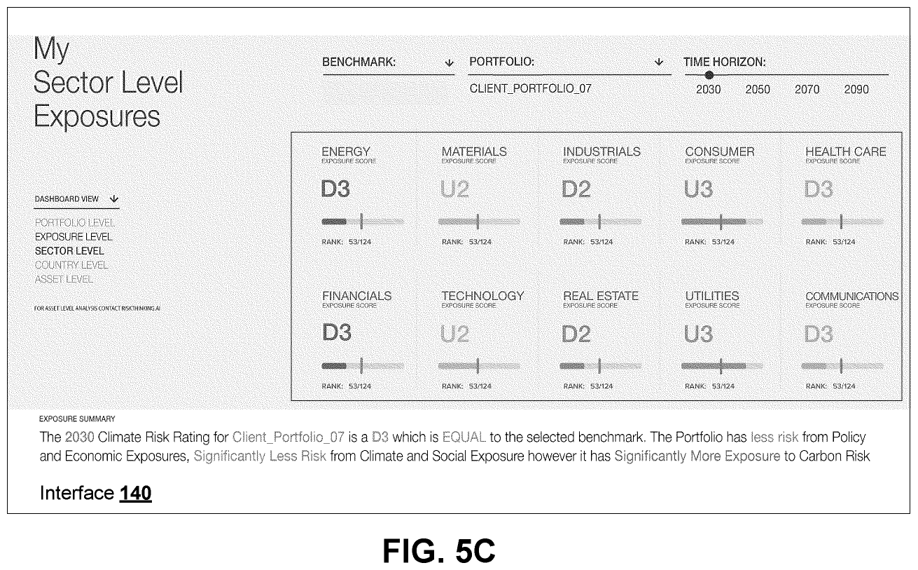

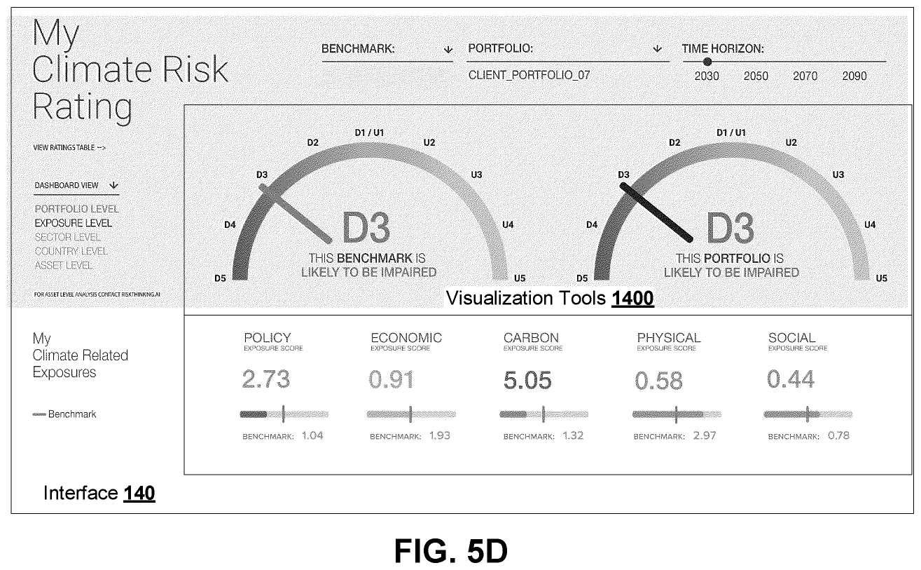

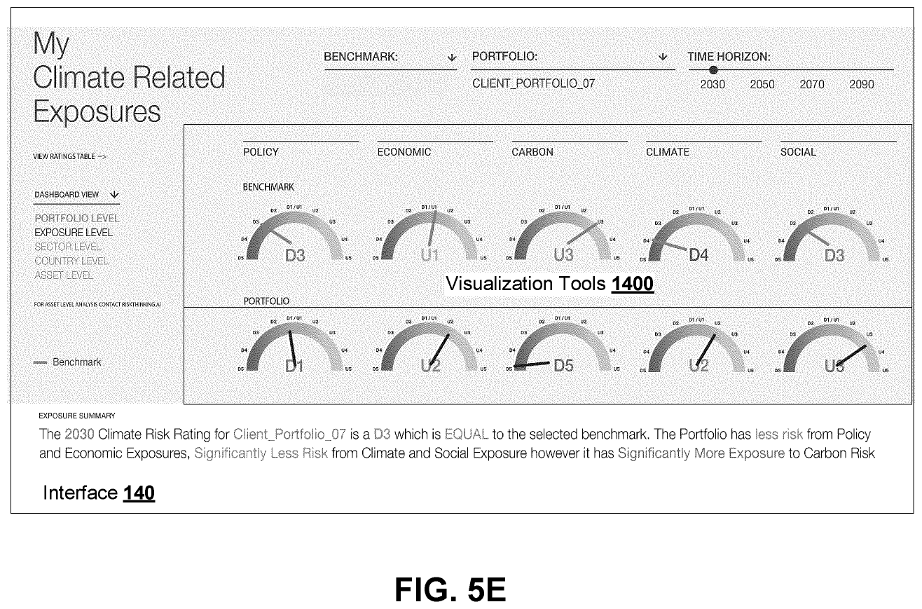

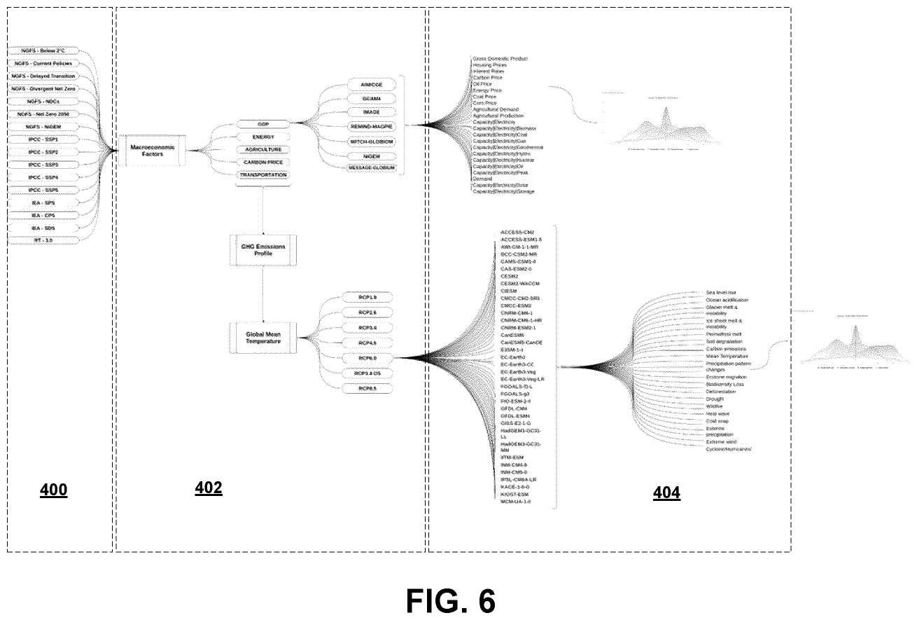

FIG. 5 shows an example visualization indicating Rating Transition Exposure. The visualization has a scale or gauge that can be generated at an interface. The scale represents different ratings. A rating of U3 refers to an asset with an upside due to climate stress that is three times the downside. D4 refers to an asset with a downside that is four times the upside. The rating visualization can provide useful data. The rating visualization can be applicable to Transition, Physical and Investment risks. The rating visualization may be used for any type of climate risk, provided one can compute the distributions of gains and losses of multifactor stress tests on the specific type of climate risk.

The rating visualization has indicators for different ratings. The rating visualization can provide an overall climate risk rating (CRR™). The following table has different example ratings and explanations.

| | | Exposure | |
|---|---|---|---|
| Rating | Explanation | Score D/U | Description |
| D5 | Downside is 5 times | 4.609+ | Highly Likely to be |
| | the Upside | | severely impaired |
| D4 | Downside is 4 times | 3.391 to 4.608 | Highly likely to be |
| | the Upside | | impaired |
| D3 | Downside is 3 times | 2.609 to 3.390 | Likely to be impaired |
| | the Upside | | |
| D2 | Downside is 2 times | 1.391 to 2.608 | Likely to be somewhat |
| | the Upside | | impaired |
| D1 | Downside approx. = | 1.001 to 1.930 | Likely to be slightly |
| | the Upside | | impaired |
| U1 | Upside approx. = | .609 to 1.000 | Likely to be slightly |
| | the Downside | | positively impacted |
| U2 | Upside is 2 times | .391 to .609 | Likely to be somewhat |
| | the Downside | | positively impacted |
| U3 | Upside is 3 times | .276 to .390 | Likely to be positively |
| | the Downside | | impacted |
| U4 | Upside is 4 times | .225 to .275 | Highly likely to be |
| | the Downside | | positively impacted |
| U5 | Upside is 5 times | .225 or less | Highly likely to be very |
| | the Downside | | positively impacted |

Each type or category of rating can have a corresponding range of exposure score. The interface with the rating visualization can indicate different categories of ratings and move an indicator to visually indicate the category of rating that corresponds to a calculated exposure score.

When stating a climate exposure rating it is necessary to qualify it with respect to the factor that is chosen. As an example, to be precise, the system and interface can provide output data such as: “Your overall rating is a U3 with respect to a world average temperature of 1.5 degrees by 2100”.

The choice of which Transition Scenarios are included in the portfolio of transitions, upon which the system can base its analysis will have an influence on ratings. The quality of the Transition Scenarios will also affect the ratings, particularly the ratings of the 5 chosen macro factors. For example, the POLICY factor can be captured by scenarios. Using this framework, however, the system can generate the components that can be included in future sets of Transition Scenarios.

Note that the system does not restrict the measurement of Transition Risk or Physical Risk to a single choice of Transition scenario. This avoids treating a fundamentally stochastic problem as a deterministic one.

To be able to measure the risk with respect to a set of Transition Scenarios the system can evaluate the impact of the transitions. This requires evaluating the impact on a company, a physical asset or a particular country.

### Physical Risk

Calculating the impact of transition exposure on a physical asset can be done in different ways. For example, calculating the impact of transition exposure on a physical asset can be done by valuing the stress(exposure) to the asset using a “damage function”. As another example, in cases where the system has the appropriate knowledge of the asset, the system can calculate a distribution of the gains and losses to the asset with some precision. The first of these examples may be used when looking at an aggregate view.

To obtain the impact of these stress scenarios on physical assets and to understand the potential financial losses they could incur, requires details of the assets that, for the most part, are not available easily. When such data is available it is a good choice for evaluating impacts. When clinical data on an asset is not available, the system can assume a damage function and apply it to the asset, but this may not be reliable. However, for large groups of assets in a given region, or sector, a well-chosen damage function might be adequate for assessing impact.

Another example is for the system to use machine learning and graph theory to extract a damage function from the cumulative knowledge in recent scientific, economic and social literature to estimate costs.

### Investment Risk

For financial assets, assessing the financial impact of climate on a portfolio involves stressing the asset and valuing the impact. This requires converting the macro stress tests to stress tests involving micro-factors used to value the asset. There are many different accepted ways to generate the micro from the macro factors.

The end result is that for each path (combination of the 5 macro factors) there is a corresponding shock to a portfolio that can be calculated with traditional financial engineering methods. The result is a set of multifactor shocks with their corresponding shocks to the portfolio and corresponding likelihoods. The process then looks much like the one described above for Physical assets.

### Potential Stranded Assets

High exposure to one or more factors can lead to a stranded asset, that is, the lack of the ability to fund the asset from its earnings. Since two different subsidiaries or entire companies or, for that matter countries, each with almost identical assets, may experience the same exposure, their capital structure would differ, and hence what is a stranded asset for one may just be a painful pivot for another. For that reason, and in the absence of more data on the actual asset and its financial realities, the system can focus on the possible impairment level based on extreme stresses.

By way of illustrative example, consider two steel manufacturers, one based in India and another in the US. The table provides an example rating for these two entities for Carbon Risk. The Indian entity was a D3 and the US company a D5 on the rating output. This translates to the Indian company being less much susceptible to Carbon exposure than its US counterpart. The overall climate risk rating (CRR™) is a D2 for the Indian company and a D3 for the US company, showing a slightly less negative exposure to climate for the Indian company.

| Risk Factors | India Steel | USA Steel |
|---|---|---|
| Policy | D2 | D2 |
| Economic | D3 | D4 |
| Carbon | D3 | D5 |
| Climate | D2 | D3 |
| Social | D2 | D4 |
| CRR | D2 | D3 |

For the transition scenarios, the US implied carbon price may be significantly more than its Indian counterpart, for example. This differential could become even more extreme which may suggest a shift in manufacturing steel to India. There can be further analysis of these two example steel companies using the example macro factors.

Both India and the USA have committed to tackling climate change through policy levers. For example, both have defined Nationally Determined Contributions (NDC) and have committed to the aspirational goal of achieving Net Zero by 2050. These commitments initialise the causal links in the scenario generating process, effectively starting each region off from the same point, hence the same level of exposure (D2).

A common indicator of economic performance at the national scale is the Gross Domestic Product (GDP), specifically its rate of growth. Economies that see a sustained level of growth generally perform better than stagnant economies. There also may be more resources available to the population and the standard of living increases as does the per capita income.

Over the past 30 years (1990-2020) India's GDP increased 200% compared to a USA GDP increase of 130%. Under all Transition Scenarios, over the next 30 years (2020-2050) India's GDP is projected to increase on by as much as 600% compared to the USA's projected increase of 190%. This may indicate that India's GDP will possibly accelerate at a faster rate as this pattern is repeated across the majority of economic variables. Given that two countries are striving to achieve similar goals with regards to climate policy the projected economic landscape appears to favour India.

Both countries have committed to implementing a price on carbon over the next 30 years. However, the carbon price in the USA is generally 1.5 times higher than that implemented in India over the same time period, and across all Transition Scenarios.

Both countries will experience climate impacts from heat, flood and winds. The location of material assets and the magnitude of change to the physical risk factors over time is an important consideration. India's manufacturing sector may not be significantly more exposed to physical risks than it is today. In comparison the USA manufacturing sector, based on its location of assets (railway lines and factories) may experience unprecedented heat waves, drought and flooding events.

Social exposure can be derived as a proxy of the national GDP. Increased GDP typically follows an increase in disposable income, lower interest rates, access to new technologies and resources, lower cost of living, cheaper and more accessible energy. These variables can be extracted from the Integrated Assessment Models (IAM). Under all scenarios India's cost of living is lower than that of the USA.

The results of this example study are based on available NGFS, IPCC and IEA transitions.

Embodiments described herein provide a method for linking Transition and Physical risks. The method and system can use a distribution of Transition Scenarios whose primary goal is to understand the possible uncertainty in each risk factor at the horizon in question. The method and system enhance uncertainty estimates using machine learning by processing recent, trusted scientific papers using natural language processing. The method and system can generate a distribution of forward-looking, multifactor stress scenarios to stress the physical or investment asset. The method and system can generate a rating of an asset in question (e.g. as received as input) to indicate how much upside and downside there is relative to a desired result or some other benchmark.

The process and system can be consistent over markets and sectors within markets and respects the stochastic nature of transitions. Given more financial information on the assets, the process and system can estimate the cost of abandoning or retrofitting the asset and hence to amount needed to finance a pivot to net zero or a lower carbon future.

The CRCS™ hierarchy can be used by embodiments described herein to consistently classify transition and physical risk related to climate change. CRCS provides a robust, consistent and scalable computing hierarchy for understanding and comparing exposure to climate-related risk. CRCS can be used by embodiments described herein to respond to the global financial community's need for a globally comprehensive, accurate, and auditable approach to defining and classifying climate risk factors and determining their economic impact. CRCS can be used by embodiments described herein to quantify both risks and opportunities presented by climate change, climate-related policy, and emerging technologies in an uncertain world. Embodiments described herein relate to computer systems that generate data structures using classification standards and scenarios for climate and financial risk consistently and at scale. The computer system derives data representing the uncertainty of these factors in the future; and uses this information as input for scenario generation.

Embodiments described herein relate to computer systems and methods for generating ontologies of climate related risk (e.g. as knowledge graphs or data structures) to return a structured, codified and accessible data structure that can be queried by a client application.

There are different example financial risks associated with climate change: transition risks; physical risks; investment risk; credit risk; social risks; governance risks; policy risks, economic risks, carbon risks.

The description will consider physical and transition risks as an example.

Physical risk is the risk associated with the future climate's potential impact on a physical asset or region. For example a building can be exposed to physical risk from flooding, an agricultural region can be exposed to physical risk from drought. A workforce can be exposed to physical risk from heat stress and so on. It is the physical realisation of an impact on people and property.

Transition risk is the risk associated with a shift within an economy to new and novel energy sources, shifts in capital allocation, changes in population demographics, shift in societal living patterns (rural to urban migration), and so on. The world has acknowledged that we must shift from a high carbon economy to a low carbon economy. Transition scenarios represent economic configurations that will facilitate this shift. The risk is which sectors and regions of the global economy will benefit and which will lose out.

FIG. 5A shows a visualization of the distribution of impacts from stress testing. The gains are shown in green, and losses are shown in orange, as an illustrative example. Risk can have a common feature. A goal in a multifactor stress test will be to generate a visualization of distribution of the impacts, such as in FIG. 5A, when the multifactor stresses are applied. The visualization can represent ratings of risk. Exposure ratings refer to the climate stressors (e.g. stochastic analysis of the multifactor climate stresses on an asset). FIG. 4 shows an example of output for an stochastic analysis of the multifactor climate stresses on an asset. That is, FIG. 4 shows an example visualization of multifactor distribution of climate stressors. In comparison, climate risk ratings are obtained when the system evaluates the financial impact of a stress scenario on an asset. FIG. 5A shows an example visualization of climate risk ratings. Risk ratings are obtained when the system can evaluate the financial impact of a stress scenario on an asset.

Embodiments described herein provide a computer process for generating integrated climate risk data to generate a set of climate stress scenarios to measure or estimate impact on a business unit. The output data can be used to generate visualizations for an interface 140 (see FIG. 19) that aggregate gains and losses and forms a distribution of the gains (Upside) and losses (Downside).

A goal in a multifactor stress test is to generate a distribution of the impacts. These impacts can be beneficial or detrimental and the ratio of the upside over the downside gives you a useful metric, which can be referred to as climate-risk adjusted return (CaR™).

Embodiments described herein provide a computer process for generating integrated climate risk data rating metrics. An example metric can be referred to as “CaR” or Climate-risk adjusted Return. CaR can show the impact of climate change on an asset. CaR is computed by dividing the Upside by the Downside as a measure of the risk-adjusted upside. Embodiments described herein can be used to generate visualizations of bar graphs for the distribution of the gains (Upside) and losses (Downside). The Upside can be given by an area covered by a first section of bars and the Downside can be given by an area covered by another section of bars.

A CaR of less than one implies a likely financial impact on profitability under these stresses. A CaR value less than one may be interpreted as the asset being stressed is more likely to be negatively affected by Climate Change in the future than positively. A CaR value greater than one may be interpreted as the asset being stressed is more likely to be positively affected by climate change than negatively.

Embodiments described herein provide a computer interface with visualizations indicating a climate risk rating (CRR).

FIG. 5A shows an example visualization indicating a CRR has a scale or gauge that can be generated at an interface 140 (FIG. 19). The rating visualization can provide useful data for an interface given the display constraints of computing devices. The rating visualization can be applicable to different types of risks (e.g. Transition, Physical and Investment). In fact, the visualization may be used for any type of climate risk, provided one can compute the distributions of gains and losses of multifactor stress tests on the specific type of climate risk.

The system can generate the forward-looking stress scenarios that lead to the distributions of gains and losses. The system can derive the distributions of risk factors in a particular climate region at some future points in time. The system can focus on transition scenarios to describe an estimation of future data.

A transition scenario is a narrative of the future behavior of an economy at the country or global scale and its resulting impacts to economic sectors within a target economy. Since we are dealing with the future, the way a particular transition affects the future is radically uncertain. The randomness of the future is not only due to the passage of time and the vagaries and random events that can occur but also due to the many plausible climate and economic models that are used to describe the future. These models bring an inherent uncertainty with their differing views on the economy and the climate at future points in time.

To capture this uncertainty, the system can account for published experiments with many trusted climate models, for each climate risk factor for each transition scenario. There will be constant updates to these models and the data they use, and the experiments produced with them. This is a moving target and needs to be updated constantly.

FIG. 5B shows an example of interface indicating Sector Level Exposure fora Climate Rating. The visualization for interface 140 can indicate different CRR values as a scale or gauge that can be generated at an interface 140 (FIG. 19), and updated in real time as new data is acquired by the system. The rating visualization can provide useful data for the interface given the display constraints of computing devices. The rating visualization can be applicable to different sector levels of risk exposure to provide different types of rankings, such as an energy ranking, material ranking, industrial ranking, consumer ranking, health care ranking, financial ranking, technology ranking, real estate ranking, utilities ranking, and communications ranking. In fact, the interface can be used to display visualizations for any type of climate risk ranking, provided one can compute the distributions of gains and losses of multifactor stress tests on the specific type of climate risk.

Figure SC shows an example visualization of interface 140 (FIG. 19) indicating Climate Risk Rating for Sector Level Exposure. In this example, the interface has different types of rating visualizations that can provide useful data for an interface given the display constraints of computing devices. The interface shows an example visualization for rankings related to energy, materials, industrials, consumer, health care, financials, technology, real estate, utilities, and communications. The interface also provides benchmark data for each type of visualization.

FIG. 5D shows an example visualization of interface with multiple gauge type visualization tools 1400 indicating Climate Risk Rating Exposure. There can be a gauge type visualization for different levels of risk measurements, including portfolio level risk, exposure level risk, sector level risk, country level risk, and asset level risk. The interface can also have visualizations for different macro factor risks, such as policy, economic, carbon, physical, and social, along with benchmark data values to provide visual comparisons.

FIG. 5E shows another example visualization of interface 140 with visualization tools 1400 indicating Climate Risk Rating Exposure. The example visualization tools 1400 of interface 140 shows multiple gauge type visualizations indicating Climate Risk Rating Exposure for different macro factor risks (e.g. policy, economic, carbon, physical, and social), along with benchmark data values to provide visual comparisons. Using the scenario sets consistently for different assets and organizations enables the generation of visual comparisons at interface 140.

FIG. 6 shows a visualization of a mapping of transition scenarios and their relationship to future climate and macroeconomic risk factor uncertainty. The way a particular transition scenario relates to the uncertainty in the climate and economic risk factors is captured by digital links of the mapping shown in FIG. 6. The visualization of the mapping can represent the CRCS. The system can compute distributions for macro risk factors for the time horizon using integrated, codified climate risk data structures. The system can compute the distributions for macro risk factors by a convolution of micro risk factor distributions to generate distribution measurements for the plurality of macro risk factors. The distributions for the macro factors can be used to generate the multifactor scenario sets. To obtain consistency across markets, and sectors within markets, the system can use multi-factor scenario generation. The system uses the individual factor distributions as inputs and produces multifactor scenarios as outputs. In this way, the same methodology can be used across and within markets for multifactor stress testing.

Each of the macro risk factors are made up of many micro risk factors, scattered over many geographical locations. The risk factors are used to evaluate the impacts of climate stress on a portfolio of assets. The micro risk factors can be random variables, and at any point in the future horizon they are represented by uncertainty distributions. The individual macro factors can also be represented by uncertainty distributions, which are derived from the (weighted) convolution of the micro risk factor distributions.

The system uses a scenario generation method to generate multifactor stress scenarios on combinations of these factors for each horizon in the future that is of interest. This amounts to transition stress scenarios. The end result has interesting properties: the best and worst scenario for each factor is contained in the scenario set. This can be referred to as a spanning set of stress scenarios over time.

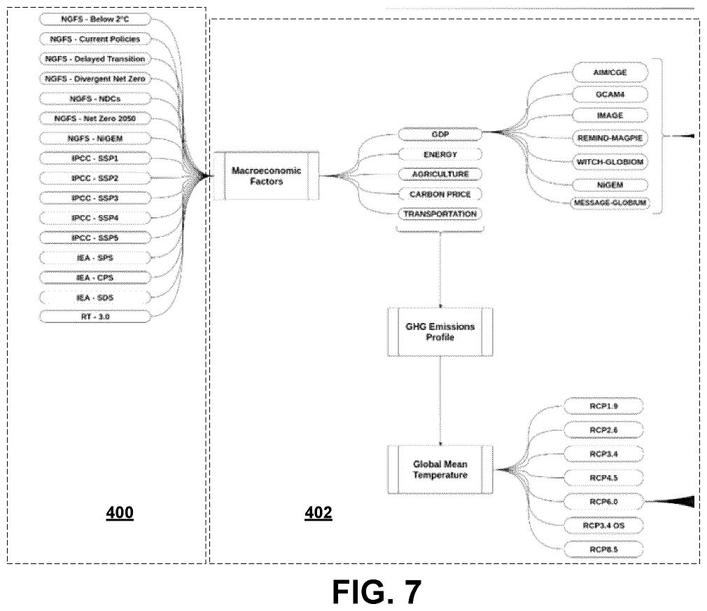

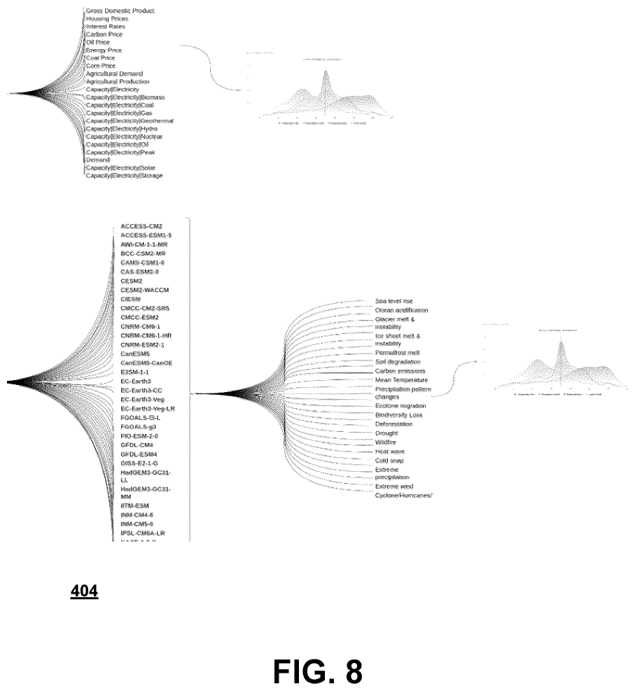

FIG. 6 shows a visualization of a mapping with regions 400, 402, 404 which are enlarged in FIGS. 7 and 8 to show further details of example transition scenarios.

The region 400 shows example transition scenarios. For each transition variable there is a suite of models that can be used to project values. The values drive different indices. Profiles are defined by different variables and factors. The transition scenarios drive the RCP outcomes. The RCPs have different models to project values. The system can extract different factor sets for the different example risk factors: policy, economic, carbon, climate, social macro risk factors.

The mapping for transition scenarios can be a causal graph of nodes having edges connecting the nodes to create transition scenario paths for a risk model. The nodes define a network structure of the risk factors with links between nodes. As shown in FIG. 7, a root node of transition scenarios 400 can correspond to transition scenario paths with connections or links to macroeconomic factors and GHG emissions inventory. The macroeconomic factors are linked to nodes for different factors such as GDP, energy, agriculture, carbon price, and transportation. The GDP factor can be linked to nodes for the model output from IAM's (AIM/CGE, GCAM4, IMAGE, REMIND-MAGPIE, WITCH-GLOBIOM, NIGEM, MESSAGE-GLOBUM), as examples. The GHG emissions inventory are linked to a node for Global Mean Temperatures which is turn is linked to nodes for different physical climate perturbations such as RCP1.9, RCP2.6, RCP3.4, RCP6.0, RCP7.0, RCP8.5. The transition scenario paths can be defined by different linked nodes, for example.

Given a transition scenario, the system can trace the evolution of many economic risk factors going forward in time. The evolution of the economy implies an evolution in CO2e in the future, which, in turn, implies a range in the evolution in the global mean temperature. This in turn, creates two distinct sets of views on the future. One economic view and a climate related view. The models and their underlying assumptions must be updated continuously as new data becomes available and new scenarios are derived.

On the economic path, the transition scenarios are prescriptive regarding the economies of the world, expressed in terms of their macroeconomic drivers (i.e. population growth, GDP, agricultural demand and production, energy type, capacity and demand). The future state of the economy is modelled using integrated assessment models (IAMs). These models dynamically model the movement of capital and resources throughout sectors and counties. An interesting aspect of these models is that they define an emissions profile of the economic sectors being modelled through time. The end of the top branch is a distribution of economic variables at multiple time horizons that are related to a climate outcome (global mean temperature) through their GHG profile.

The bottom branch of FIG. 6 traces the generation of climate risk factors from over 40 global climate models that align to the economic outcomes. The result is a set of distributions of climate risk factors at multiple time horizons for every economic transition scenario.

The system can obtain a consensus view of the science and its inherent uncertainty through Structured Expert Judgement (SEJ). There are different paths to obtain data through SEJ. One example is direct polling of experts in a structured survey, complete with control questions and statistical inference of trustworthiness. A second example is a machine learning approach using natural language processing (NLP) to extract the latest observational and experimental results. The system can employ both paths for different purposes, surveys are conducted to achieve real-time views of current events and likelihood of achieving a particular transition goal (i.e. net zero by 2050). NLP is employed to adjust the forward-looking distributions to be weighted towards the state of the science.

The net result is many potential future values for every climate risk factor for every horizon chosen, for every geographical location. These results are summarized in an uncertainty risk distribution for each factor for each time-period going forward. As an analogy, the experiments conducted with RCP models may be similar to sampling the views of scientists regarding possible future transitions.

The system can apply a metric to models to test their reliability as a harbinger of future climate. This is the equilibrium climate sensitivity (ECS) and transient climate response (TCR). These are measures of how sensitive the climate system is to changes in carbon concentrations. These metrics tell us if a model is running too hot or too cold, allowing us to un-weight these models from the distribution. The other factor to account for in the generation of distributions is to harmonise the model outputs so that the volume of model runs for a particular RCP (i.e. RCP8.5) is not counted as an endorsement of the veracity of that scenario.

This can be repeated for all risk factors and for every transition scenario, for every time period for every hexagon on the planet. The net result can capture the uncertainty in each climate and macro-economic risk factor at each forward time-period. With such a large and diverse sample size the possibility of capturing extreme tail risk is inevitable.

The system can generate temperature metrics for climate risk measurement. To align the system analysis to a particular temperature range in the future, the system can restrict the transition scenarios (experiments) that are chosen to match that range.

Transition scenarios can involve different variables or parameters. The system can develop forward looking uncertainty distributions on a large range of economic factors as illustrated in FIG. 6.

With the CRCS™, this data can be aligned by the system to provide all this data at every tile (geographic location) on the earth's surface, including the oceans (FIG. 1).

The net result of this illustrative example is that there are many possible future values for every climate risk factor for every horizon chosen, for every geographical location. These results can be summarized in an uncertainty risk distribution for each factor for each time-period going forward. As an illustrative analogy, the experiments conducted with RCP models may be similar to sampling the views of scientists regarding possible future transitions. It is also possible to weigh the experiments. The weights could be obtained by Structured Expert Judgement in some embodiments.

This is repeated for all risk factors and for every transition scenario of interest. The net result is that we have captured the uncertainty in each climate and macro-economic risk factor at each forward time-period. With such a large and diverse sample size the possibility of capturing extreme tail risk is vastly improved.

The system can provide an interface for climate related financial risk (FIG. 9).

The system can generate forward-looking multifactor scenarios stored as code in non-transitory memory for us in generating output.

The system can populate memory with climate data for the world at a detailed level, including derived data on the distribution of economic and climate risk factors at any horizon tuned to any geography. The system can use these distributions to generate output data.

Forward distributions on the risk factors are the inputs to a multifactor scenario generator. The system can handle arbitrary combinations of risk factors to obtain multifactor stress scenarios. This includes climate, political and economic factors.

FIG. 9 shows an example illustration of system components and input data, including Structured Expert Judgement data, Climate data, Transition Scenarios, Geophysical data, Financial data, and asset data. The system processes the data and stores the data in memory to populate the macro risk factors (policy, economic, carbon, climate, social).

FIG. 10 shows an example illustration of CRCS with climate region data and Transition Scenarios providing input data to the macro risk factors (policy, economic, carbon, climate, social). For example, the climate macro risk factor provides data to climate drivers, climate elements, and climate risk (chronic risk, acute risk).

FIG. 11 shows an example illustration of climate risk.

FIG. 12 shows an example interface with visualizations for codifying climate data for financial markets.

The system can enable automated feature selection using the distributions of the values of the different indices or variables. The parametric curve of the distributions can be used to project values for future events or unseen events. The distribution encapsulates the risk of the scenario.

As an example, risk indices can be defined by 8 physical scenarios by 44 transition scenarios by 40 models over a time series. The system can account for parametric distributions, such as: GEV (generalized extreme value) distribution, extremes follow GEV distribution, Weibull distribution (frequency data, data with upper/lower bounds), skewed Normal, Normal, Goodness of fit test applied to every risk index for every scenario. The system can generate output for each distribution along with the empirical distribution.

The system can provide global distributions using a weighting based on the number of models per scenario. The system can normalize the scenarios and determine how accurate a given model is, as some models perform better than other models. The system can use SEJ data to compute most likely scenarios given current conditions. The weighting can include a first weight based on the number of models per scenario, a second weight based on equilibrium climate sensitivity, and a third weight based on an SEJ derived scenario probability.

FIG. 13 shows an example illustration of an interface with output data shown for each hexagon for the geographic region shown.

FIG. 14 shows example distributions for an application for heatwaves. The system can condense large amounts of data from multiple models and scenarios for an entity. The distributions relate to transition exposure ratings (upside or downside) indicating relative change of risk index compared to a baseline.

FIG. 15 shows further example distributions for the application for heatwaves. The system defines exposures to calculate ratios. The system defines extreme historical conditions, and computes the likelihood of those conditions in the future. The ratio can be the probability of a future event over the probability of a historical event. In the example of FIG. 15 the ratio can be 5.7 which indicates how much more likely the event will occur.

The system can compute ratios for each risk factor and then aggregate them to get the total exposure.

The system can compute indexed macro risk factors. For example:
Iₚₒ=Fₚₒ{Hydrogen, Renewables, No gas cars after 2035, . . . }
I_{ec}=F_{ec}{GDP, LT Interest Rates, Investment in renewables, . . . }
I_{ca}=F_{ca}{Implied carbon price, CCS, Emissions, . . . }
I_{cl}=F_{cl}{Sea Level Rise, Heat Wave, Wildfires, . . . }
Iₛₒ=Fₛₒ{Cost of Living, Cost of Energy, Food Demand . . . }

The system can implement natural language processing, text mining and graph theory.

The system can use natural language processing (NLP) to identify climate risk factors by location, time period and emission pathway. The system can condense the enormous amounts of unstructured text from tens of thousands of journal articles into candidate words and phrases using natural language processing. The system can remove punctuation, special characters and common stop words. The system can replace words with its basic syntactic form (lemmatization). The system can create a corpus of words and phrases from the raw text input data. The system can pool documents by the highest Term Frequency by Inverse Document Frequency (TF-IDF) score.

FIG. 16 shows an example graph structure for results of NLP. The system can explore the network structure of climate risks from documents, and the system can combine NLP with Graph Theory to detect “communities” in bipartite networks.

The system can implement NLP for sentence boundary detection and generate a bidirectional long-short term memory neural network representing processed text data. The system can implement NLP for parts of speech tagging to generate a linear layer with softmax activation function on top of the token-to-vector layer from a transformer-based model. The system can implement NLP for dependency parsing to generate a transition layer on top of the token-to-vector layer. The system can implement NLP for named entity recognition using a hybrid method of a collection of pattern rules and pretrained models. The system can implement NLP for relation extraction using classification and pattern matching. The system can implement NLP for entity linking.

FIG. 17 shows an example illustration of (a portion of) a complexity matrix. The complexity matrix defines the five example risk factors and a corresponding hierarchy of data. The complexity matrix also defines an area for data and indicates how the system acquires the data, standardises the data and aligns the data. The process follows a causal process wherein data informs Policy that drives Economy that defines Carbon that influences Climate which impacts Social to create data, and so on.

FIG. 18 shows an example illustration of calculating exposure at a specific location. The system can navigate the complexity matrix by search through a spatial and temporal layer that returns the universe of risk at a specific place and time. The magnitude of change in the likelihood of a risk occurring is that location exposure and any given time. The image is an example visual representation of the data structure.

Raw unstructured data enters the matrix and is aligned along the spatial and temporal dimensions. The data is stored by a unique node identifier that scales to any nominal spatial resolution while maintaining a strict relationship to the parent or child nodes. It is also aware of neighbouring nodes at the boundaries. The entire universe of data is aligned to this node and partitioned by a temporal identifier. The structure risk can be calculated across the 5 macro factors; Policy, Economic, Carbon, Climate, and Social, as these are embodiments of the aligned universe of variables. The structure is not limited to these 5 factors, any number of arbitrary macro factors can be defined and embodied in the risk calculation.

Many climate events are the result of multiple risk factors coming together in some combination. An example is forest fires which are combinations of heat, drought, and high winds. The system can generate scenarios on these combinations of factors.

The system can automate scenario generation which makes it possible to generate scenarios in a consistent fashion within and across markets. The system can automatically generate ratings and evaluate climate related financial risk. The system can measure transition and physical risk.

The system can generate worldwide data at different resolutions, with standards for aligning data using CRCS, methods for deriving forward looking uncertainty at any horizon, and has the ability to generate multi factor stress scenarios for these horizons. The system implements a process for calculating climate financial risk for transition, physical assets, and investment portfolios.

The transition risk of a corporation or organization is the possible effect climate change may have on the company due to the uncertainty of the economic transition to a lower carbon world.

Given the data assembled by the system, and the stress scenarios that the system generates, the system applies these stress shocks to the balance sheet data of an organization to obtain a distribution of possible gains and losses to the firm at some horizon. Since the balance sheet data may have credit, physical, collateralized loan, and investment exposure (treasury) data, the system can compute the effect on each of these which might involve the physical risk, investment risk and credit risk, for example. The advantage of the framework of the system is that it is completely consistent across all of these.

The positive and negative impact to the institution can be summarized in a distribution with the ability to view which shocks cause a particular gain or loss. From this the system can obtain a CaR value. This indicates whether the firm is negatively or positively affected by climate change. From these results the system can generate output indicating an overall rating for the organization.

The system can do this for the firm at any level, in any geography or financial sector thereby creating a map of where change is needed and how better to allocate capital.

The physical risk to an organization due to climate is the value of the impact of climate shocks applied to its physical assets at some horizon. When the system captures data for the locations of the physical assets, and the standards and methodology for consistent data and generation of stress tests, the system can understand what shocks or combination of shocks affect the physical portfolio at any chosen horizon. With that data, the system knows where to take action to mitigate the risks or adapt to them and when to take that action.

With sufficient financial information on the assets, the system can obtain data for the addresses of the assets and other information regarding the management of the assets to obtain the cost or benefit of strategies to remediate the portfolio or rebalance it.

The system can categorize, unify, align and maintain climate risk data worldwide. The system uses its standards to guide alignment of the data. There is also derived data, constant updates in climate data, uncertainty in science data, and relationships to the economics of each region. To add to this, it is the risk of climate change that can be computed by the system using forward-looking data for radical uncertainty. This requires derived data which has to be gathered and aligned using machine learning and sentiment analysis.

Embodiments described herein provide a comprehensive, science-based, dynamic, API-accessible data system for measuring and managing climate related transition risk data. The system processes and stores climate related data aligned with the CRCS™. The system combines security with the ability to trace any piece of data to its source and to the processes used to create alignment. It is client ready, all data being easily accessible for download via API for use in internal applications.

The climate data covers the entire surface of the earth, including oceans. The system uses data corresponding to sentiment of trusted experts and the wisdom of their combined views of the future. It has an analytical engine to enable stress testing of physical and investment assets using generated, forward-looking, multifactor scenarios. The system can implement supply chain climate risk management using transition scenarios, for example.

The system scales and can be extended, virtually and anonymously with a firm's proprietary data. The system provides a platform for distributing data within and outside an institution, enabling collaboration between units and with counterparties.

Embodiments described herein provide a computer system to automatically test the impact of radical uncertainty on financial portfolios. Radical uncertainty can be represented by events or combinations of events that are unprecedented in historical data or are historically unlikely. Financial stress tests have relied on historical correlations and regression analysis of past events to foretell future impacts. However, underlying macro factors of the risk potential, defined by their frequency distribution, are changing beyond their historical bounds. The impact of changes is unaccounted for as methods traditionally have no recourse to deal with radical uncertainty.

Embodiments described herein provide a computer system that addresses the radical uncertainty inherent in the world by automatically generating a set of scenarios that account for a wide range of risk potentials, including extreme events. The computer system accounts for the tail end of the uncertainty distribution explicitly and provides a measure of the likelihood that a particular path within the set is realised in the real world. The ultimate goal is stress testing to understand the risk reward trade-offs and the stability of institutions and markets.

As an illustrative example, the impacts associated with risks are geospatial by nature, floods occur within a catchment, pandemics begin as regional epidemics, and so on. To address this, embodiments described herein provide a computer system with a geospatial partitioning engine that segments world data into climate regions following the IPCC CLIMATE CHANGE ATLAS definition of climate regions. These are large areas of land and sea that experience similar climatic conditions. These regions are further divided into climate geo-zones characterized by sub-tiles at a higher spatial resolution.

FIG. 19 is a view of an example of the system with servers and hardware components. The example computer system with a hardware server 100 for computer models and scenario generation. The server 100 has a multi-factor scenario generator 180 that automatically generates scenario sets. The server 100 has a CRCS 250 that involves a computer hardware processor configured to consistently classify transition and physical risk related to climate change to generate input data for computer models. The CRCS 250 integrates with a machine learning pipeline 160 (with a natural language processing pipeline 165) to extract information from unstructured text, classify the risk, the multitude of dimensions that define a risk, quantify the interconnectedness of risk factors, and return a structured, codified and accessible data structure that can be queried. The CRCS 250 provides alignment of data (e.g. distributed data sets from different input sources) so that it can be processed by server 100 in a consistent way.

The server 100 has a multi-factor scenario generator 180 that automatically generates transition scenarios. Transition scenarios can model the evolution of an economy at the country or global scale and its resulting impact on sectors. The server 100 can compute distributions for macro risk factors for the time horizon using integrated, codified climate risk data structures. The server 100 can compute the distributions for macro risk factors by a convolution of micro risk factor distributions to generate distribution measurements for the plurality of macro risk factors. The distributions for the macro factors can be used by the multifactor scenario set generator 180. To obtain consistency across markets, and sectors within markets, the server 100 can use multi-factor scenario generator 180 to generate spanning sets. The server 100 uses the individual factor distributions as inputs and the multi-factor scenario generator 180 produces multifactor scenarios as outputs. In this way, the server 100 uses the same methodology across and within markets for multifactor stress testing.

Each of the macro risk factors are made up of many micro risk factors, scattered over many geographical locations. The server 100 uses risk factors to evaluate the impacts of climate stress on a portfolio of assets. The micro risk factors can be random variables, and at any point in the future horizon they are represented by uncertainty distributions. The individual macro factors can also be represented by uncertainty distributions, which are derived from the (weighted) convolution of the micro risk factor distributions.

The server 100 uses the scenario generator 180 to generate multifactor stress scenarios on combinations of these factors for each horizon in the future that is of interest. This amounts to transition stress scenarios. The end result has interesting properties: the best and worst scenario for each factor is contained in the scenario set. This can be referred to as a spanning set of stress scenarios over time.

The hardware processor 120 can compute the convolution of the micro risk factor distributions using simulations. The micro risk factor distributions correspond to a plurality of micro variables for the macro risk factors. For example, the simulation can be based on a Monte Carlo simulation.

Each macro risk factor can be defined by a set of micro risk factors having corresponding micro risk factor distributions over time. The processor 120 computes a distribution measurement for the respective of macro risk factor using a convolution of the micro risk factor distributions. The macro risk factors can be of different types, such as: a policy macro risk factor, an economy macro risk factor, a carbon macro risk factor, a physical macro risk factor, and a social macro risk factor.

The interface 140 can have a visualization corresponding to a rating for an asset, and the visualization can depict a target value and the multifactor distribution of climate stressors on the asset. The interface 140 can have a visualization depicting climate risk ratings of a financial impact of a stress scenario on an asset.

The processor 120 can generate forward looking uncertainty distributions for each of the macro risk factors, in each geography, at each time horizon. The processor 120 can generate a transition scenario for a macro risk factor as a selection of the macro risk factor in a given location repeated over each time period or horizon.

The server 100 can use transition scenarios to trace the evolution of economic risk factors going forward in time. The transition scenarios can create different sets of views on the future, such as economic and climate related. The models and their underlying parameters are updated continuously as new data becomes available and new scenarios are derived.

In accordance with an aspect, the server 100 generates computer models for risk factors and scenarios to query and aggregate impact, cost, magnitude and frequency of risk for different geographic locations.

The server 100 has a machine learning pipeline 160 with a natural language processing (NLP) pipeline 165, structured expert pipeline 170, indices 175, and an integrated model pipeline 185 to generate a knowledge graph from unstructured data. The processor 120 uses the machine learning pipeline 160 and expert pipeline 170 to link computer models to macro financial variables to encode a relationship between risk shocks and financial impact. The processor 120 can respond to queries using the knowledge graph. The processor 120 uses the NLP pipeline 165 to extract information from unstructured text, classify the risk, the multitude of dimensions that define a risk, quantify the interconnectedness of risk factors, and return a structured, codified and accessible data to update the knowledge graph. The knowledge graph can be queried by server 100 in response to queries received from a client application (e.g. interface 140) via API gateway 230. Further details of the NLP pipeline 165 are provided herein in relation to FIGS. 7, 19 to 27. For example, FIG. 21 is a view of an example workflow of NLP pipeline 165 to process unstructured text and return a structured, codified and accessible data structure (knowledge graph).

As shown in FIG. 19, the server 100 has a non-transitory memory 110 storing a knowledge graph defining extracted relationships of nodes corresponding to risk factors. The knowledge graph of the nodes defines a network structure of the risk factors and n-grams with links between nodes having weight values based on shared use of n-grams by risk factors corresponding to the nodes. The n-grams can be domain specific keywords.

The server 100 has a hardware processor 120 with a communication path to the non-transitory memory 110 to generate integrated risk data structures using a natural language processing pipeline 165 to extract information from unstructured text, classify risk and a plurality of risk dimensions to define the risk, quantify interconnectedness of risk factors for the associated link values. The server 100 returns structured, codified and accessible data structures to update the knowledge graphs in memory 110. The integrated risk data structures map multiple risk factors to geographic space and time. The server 100 populates the knowledge graph and the causal graph of nodes in the memory 110 by computing values for the risk factor for the time horizon using the integrated climate risk data structures. The server 100 generates multifactor scenario sets using the scenario paths for the climate model to compute the likelihood of different scenario paths for the climate model. The server 100 generates risk metrics for stress tests using the multifactor scenario sets and the knowledge graph. The server 100 transmits at least a portion of the risk metrics and the multifactor scenario sets in response to queries. The server 100 stores the integrated risk data structures and the multifactor scenario sets in the non-transitory memory 100.

The server 100 connects to a computer device 130 with a hardware processor having a client application to transmit queries to the hardware processor 120, and an interface 140 to generate visual elements at least in part corresponding to the multifactor scenario sets and the risk metrics received in response to the queries.

In some embodiments, the hardware processor 120, for each risk factor, merges relevant text data into a risk-specific corpus for the risk factor to populate the knowledge graph in memory.

In some embodiments, the hardware processor 120, for each risk factor, creates a link between a node for the risk factor and a respective n-gram extracted from the risk-specific corpus for the risk factor based on a frequency rate for the n-gram and a relevance rate to the respective risk factor determined by keyword extraction.

In some embodiments, the hardware processor 120 generates the knowledge graph by computing a bipartite network of risk factors and n-grams, and projecting the bipartite network into a single node network of risk factors connected by edges corresponding to shared n-grams. In some embodiments, the hardware processor 120 computes edge weights between risk factors based on overlapping keywords.

In some embodiments, the knowledge graph of the nodes indicates that a respective n-gram is relevant to a plurality of risk factors to form a connection and dependency between the plurality of risk factors. In some embodiments, the hardware processor 120 uses the natural language pipeline 165 to extract the n-grams using a highest pooled score to generate a set of n-grams for each risk factor to populate the knowledge graph in memory.

In some embodiments, an expert pipeline 170 refines candidate keywords to generate the n-grams as the domain-specific keywords.

In some embodiments, the hardware processor 120 processes the unstructured text to replace each word with a syntactic form lemma to populate the knowledge graph in memory.

In some embodiments, the hardware processor 120 computes the associated values of the links in the knowledge graph using tf-idf score to link the risk factors based on shard use of n-grams. In some embodiments, the hardware processor 120 preprocesses the unstructured text to remove removing punctuation, special characters, and some common stopwords. In some embodiments, the hardware processor 120 uses the natural language pipeline 165 to continuously populate the knowledge graph of nodes by re-computing the nodes, the links, and the weight values by processing additional text data.

In some embodiments, the hardware processor 120 uses the natural language pipeline 165 to define risk-specific queries to extract raw text data from relevant articles, processes the raw text data to generate a list of tokens and predict a named entity for each token, detect and classify relationships between different entities, and defines a query to traverse the knowledge graph in an order based on a set of rules, so that only entities associated with a value of interest will be returned, wherein the hardware processor assigns a unique identifier for each entity.

In some embodiments, the server 100 has non-transitory memory 110 storing computer models as causal graphs of nodes for risk factors. Each node corresponds to a risk factor and stores a quantitative value (uncertainty) derived by a forward-frequency distribution of possible values for the risk factor at a point in time. The causal graph has forward edges connecting the nodes to create scenario paths for the computer models. The edges encode dependencies between the nodes of the causal graph. Example risk factors include climate risk factors and the server 100 can store computer risk models for climate models. Other example risk factors include pandemic risk factors and the server 100 can store computer risk models for pandemic models including epidemiological models, economics models, distance models, and so on.

The causal graph can be a directed acyclic graph or Bayesian Network, for example. The causal graph can be referred to as a scenario tree for illustrative purposes. Each node of the graph corresponds to a risk factor and stores a quantitative value corresponding to radical uncertainty. The graph provides forward-frequency distribution data of possible values for the risk factor at the time horizon. The causal graph has edges connecting the nodes to create scenario paths for the risk model. The server 100 populates the causal graph of nodes by computing the forward-frequency distribution of possible values for the risk factor at different points in time using machine learning and structured expert judgement data to link the model to macro financial variables to encode a relationship between shocks and financial impact. The server 100 generates multifactor scenario sets using the scenario paths for the risk model to compute the likelihood of different scenario paths for the risk model.

The CRCS 250 collects large datasets from different data sources (risk data 220, model data 190) and uses machine learning pipeline 160 to process the large datasets to generate structured input data for computer models and scenario engine 180. The CRCS 250 is implemented by computer hardware executing instructions to generate integrated climate risk data for scenarios on mixed risk factors. In order for the large datasets of different data formats and types to be usable for computer systems, the CRCS 250 implements processing operations to align the data to different geographic locations in a way that is scalable. CRCS 250 can change the resolutions of the data views. CRCS 250 generates a causal based hierarchy that maps climate data and multiple risk factors in space and time. CRCS 250 can enable different resolutions of data based on different geographic locates. CRCS 250 can scale back to a location (city, region) over time and spatially. CRCS 250 can encode the casualty of the changes. CRCS 250 encodes the chain of impacts on factors, when a trigger to a factor in turn triggers another factor. CRCS 250 generates a hierarchy of mapping for the data. CRCS 250 creates a computing structure of understanding for the data. The data can be in different formats and needs to be mapped or aligned or structured to be usable for computing models. The data can be input into transition scenario models for scenario engine 180 to generate forward looking prediction models.

CRCS 250 is designed to consistently classify transition and physical risk related to climate change. CRCS 250 provides a robust, consistent and scalable hierarchy for understanding and comparing exposure to climate-related risk. CRCS 250 is designed to respond to the need for a globally comprehensive, accurate, and auditable approach to defining and classifying climate risk factors and determining their economic impact. The CRCS 250 universal approach sheds light on both risks and opportunities presented by climate change, climate-related policy, and emerging technologies in an uncertain world.

CRCS 250 uses a physically consistent causal data hierarchy of measurable earth system variables and climate related phenomena covering any location (land and sea) on earth. The CRCS 250 implements a globally consistent geospatial standard that scales from climate risk regions down to the individual assets. The geospatial nature of the CRCS 250 means that any asset class or group of assets can be mapped by the CRCS 250 based on their geographic location. The standard provides a robust and consistent method for linking distributed assets at a global scale including their intermediary dependencies via supply chain disruptions.

The CRCS 250 provides a geospatial reference following the Intergovemmental Panel on Climate Change (IPCC) climate regions defined in the Climate Change Atlas. These regions are linked to climate transition scenarios (SSP and NGFS), climate elements and climate risks (chronic, acute and compound), through the climate modulators (for example ENSO, IOD, Monsoon). The climate modulators are the causal link defined by climate science, through direct and indirect (teleconnections) influence of temperature and precipitation patterns to the global atmosphere, ocean and cryosphere.

As an illustrative example embodiment, the CRCS 250 structure can consist of different climate transition scenarios, climate regions, climate modulators, climate elements and climate risks, covering chronic, acute and compound climate risks (integrated climate risk factors generated dynamically from user interaction). The CRCS 250 defines a electronic mapping to represent a causal link between transition scenarios, modulators, elements and risks to a geographic region in a consistent and science driven methodology.

The server 100 can respond to requests from interface 140 for different use cases and risk factors. The CRCS 250 processes data from the different sources to generate input for the models.

The server 100 can implement a computer process for generating integrated climate risk data by processing climate data using the taxonomy to map climate data to climate transition scenarios, climate regions, climate modulators, climate elements and climate risks. The server 100 can implement an automated rating mechanism for processing data from a variety of different sources using a consistent taxonomy. The integrated climate data can be used for scenario generation to measure the financial impact of climate change, uniformly, at some horizon, on different business units across geographies or climate regions. A business unit can operate in multiple regions and the data can be mapped to those regions.

The server 100 can implement a computer process for generating integrated climate risk data to generate a set of climate stress scenarios to measure or estimate impact on a business unit. The output data can be used to generate visualizations that aggregate gains and losses and forms a distribution of the gains (Upside) and losses (Downside).

The server 100 can provide a computer process for generating integrated climate risk data rating metrics. An example metric can be referred to as CaR, the Climate-risk adjusted Return. CaR is computed by dividing the Upside by the Downside as a measure of the risk-adjusted upside. The server 100 can generate visualizations of bar graphs for the distribution of the gains (Upside) and losses (Downside). A CaR of less than one implies a likely financial impact on profitability under these stresses. In this example, there is a section for material positive impact, a section for non-material impact, and a section for minor impact.

The server 100 generates and manages climate models, pandemic models, and other example models to respond to different types of requests. The server 100 uses CRCS 250 to generate input data for the models in response to requests. For example, the server 100 uses CRCS to generate data to query existing climate models from different computer models and calculates climate risk indices. As another example, the server 100 queries existing pandemic/epidemiological model outputs from different computer models and calculates pandemic risk indices. Other models can be incorporated as third-party input via application passing interface (API).

The server 100 has a hardware processor 120 with a communication path to the non-transitory memory 110 to process data from different data sources using the CRCS 250 and to populate the causal graph of nodes by computing the forward-frequency distribution of possible values for the risk factor at different points in time. The multifactor scenario sets are generated using the scenario paths for the computer model and scenario values are computed using the frequency distribution of possible values for the risk factors. In some embodiments, the hardware server 100 identifies macro risk factors in response to a request received from the user device 130 and generates the causal graph of nodes for the risk factors using the identified macro risk factors and dependencies between the risk factors encoded by the graph structure. The hardware server 100 generates the causal graph having forward edges connecting the nodes to create the scenario paths for the computer model. The causal relationship between risk factors are defined for each climate region. The encoding can seed the tree and arrange the nodes. In some embodiments, the relationships are updated by a named entity recognition (NER) optimiser that measures the distance between the stem words of risk factors in the scientific literature. The shorter the distance the closer the stems are to each other and the stronger the relationship between risk factors, for example.

The server 100 can use the CRCS 250 to generate input data to automatically generate scenario sets using scenario engine 180 by identifying macro factors and generating a scenario tree for the factors. The server 100 can use the scenario engine 180 to generate forward distributions of possible values for each factor at the time horizon. The server 100 can generate a set of scenarios on the combinations of macro risk factors. The server 100 can identify the extreme values and the corresponding likelihoods for each factor. A scenario is a path in the scenario tree, the scenario engine 180 having computed its likelihood as the product of the likelihoods along the path and the value associated with the scenario is the sum of the values along the path.

The server 100 can use API gateway 230 to exchange data and interact with different devices 130 and data sources, including model data 190, risk data 220, vector parameters 200, and state parameters 210. The server can receive input data from model data 190, risk data 220, vector parameters 200, and state parameters 210 to populate the computer risk models, nodes, and the scenario sets.

The server 100 can identify the micro financial factors or effects that are impacted by a set of the macro climate risk factors. The server 100 can compute valuations using a macro to micro climate conversion for each scenario.

The processor 120 has a machine learning pipeline 160 with a natural language processing (NLP) pipeline 165, structured expert pipeline 170, indices 175 (e.g., climate indices), and an integrated model pipeline 185 to generate an ontology of risk (knowledge graph) from unstructured data. The processor 120 uses the machine learning pipeline 160 and expert pipeline 170 to link the computer model to macro financial variables to encode a relationship between risk shocks and financial impact. The processor 120 can respond to queries using the knowledge graph. The processor 120 uses the NLP pipeline 165 to extract information from unstructured text, classify the risk, the multitude of dimensions that define a risk, quantify the interconnectedness of risk factors, and return a structured, codified and accessible data structure (knowledge graph) that can be queried by a client application (e.g. interface 140) via API gateway 230. The NLP pipeline 165 processes unstructured text and return a structured, codified and accessible data structure (knowledge graph).

The processor 120 implements a scenario engine 180 and generates multifactor scenario sets using the scenario paths for the computer models to compute the likelihood of different scenario paths for the computer models. The processor 120 transmits the multifactor scenario sets to a valuation engine to provide a causal map of computer risk to micro shocks for the valuation engine to translate the macro financial variables to micro shocks and output portfolio reports. The processor 120 stores the multifactor scenario sets in the non-transitory memory 110. The server 100 connects to a computer device 130 via a network 150.

The computer device 130 has a hardware processor having an interface 140 to provide visual elements by accessing the multifactor scenario sets. The computer device 130 can access the scenario data from its non-transitory memory by a processor executing code instructions. The interface updates in real-time in response to computations and data at server 100.

The hardware server 100 populates the causal graph of nodes with values (estimates) for the risk factors. In some embodiments, the hardware server 100 populates the causal graph of nodes using extremes of the distributions and a weight of the distributions above and below accepted values. In some embodiments, the hardware server 100 computes the forward-frequency distribution of possible values for the risk factor for the time horizon to extract upward and downward extreme values, and likelihoods of upward and downward movement from the forward-frequency distribution. The server 100 can used structured expert pipeline 170 to collect data for computing distributions. In some embodiments, The hardware server 100 can filter outlier data using the structured expert pipeline 170 before computing the forward-frequency distribution. That way, the extreme values are more likely to be accurate representations and not outliers or noisy data. In some embodiments, outliers are not filtered to represent the entire distribution. The outliers are valid data points just at an exceedingly rare probability. The server 100 can apply data management techniques to normalise units and formats.

In some embodiments, the hardware server 100 continuously populates the causal graph of nodes by re-computing the frequency distribution of possible values for the risk factor at different points in time by continuously collecting data using the machine learning system and the structured expert pipeline 170.

In some embodiments, the hardware processor populates the causal graph of nodes by computing the frequency distribution of possible values for the climate risk factor at different points in time using machine learning pipeline 160 (with NLP pipeline 165 and structured expert pipeline 170) to collect the possible values representing estimates of future uncertain values.

The server 100 provides a scalable automated process for generating scenarios that link different types of risk factors. For example, the server 100 can generate output to stress test the financial impacts of climate change in a scalable, consistent, auditable and reproducible manner.

The server 100 assembles a comprehensive knowledge graph or database including the most updated data on risk factors and economic drivers covering all regions around the world. The dataset contains a dynamic collection of recent, trusted, peer reviewed articles that can be updated regularly. The server 100 uses machine learning pipeline 160 (and NLP pipeline) to read these papers and summarize the uncertainty in risk factors at future points in time. The server 100 uses the structured expert pipeline 170 to exchange data with communities of experts using interface 140 and assess the sentiment on the future. The server 100 maintains complete and most current data on scientific experiments with a large number of the major models and their view on the future, month by month or over other times periods.

From all these data sources, the server 100 generates knowledge graphs or derived data that captures uncertainty in a set of related risk factors at numerous future horizons. The server 100 uses the data for generating scenarios and visual elements for interface 140 of user device 130.

As an example, risk factors can relate to pandemic risk factors. The server 100 can store computer risk models for pandemic models including epidemiological models, economics models, distance models, and so on. The server 100 can use API gateway to receive data from different data sources, including model data 190, risk data 220, vector parameters 200, and state parameters 210. The server can receive input data from model data 190, risk data 220, vector parameters 200, and state parameters 210 to populate the computer risk models, nodes, and the scenario sets.

The server 100 can generate visual elements, decisions and policies for interface 140 relating to the pandemic risk factors based on computations by scenario engine 180 with input from different data sources. For example, model data 190 and risk data 220 can include community and distancing model data from camera feeds, video input and video files. For example, vector parameters 200 can include epidemiological vector parameters (transmission rate, duration care facility, duration illness, illness probabilities, measures, effects) and economic vector parameters (household expenditure, income consumption, unemployment benefit uptake, imported input restrictions, shutdown, timing, labour productivity, export demand, wage subsidy update, government programs). For example, state parameters 210 can include epidemiological state parameters (current state infected, hospital, death, recovered, geography regions) and economic state parameters (time required to reopen, labour force, demographics, geographic controls). The server 100 uses the data to populate the computer risk models, nodes, and the scenario sets.

As another example, risk factors can relate to climate risk factors. The server 100 has computer models for climate risk models. The server 100 receives climate data from different types of data sources. The CRCS 250 processes the data from different types of data sources to generate input data and scenarios.

The CRCS 250 structure can consist of different climate transition scenarios, climate regions, climate modulators, climate elements and climate risks, covering chronic, acute and compound climate risks (integrated climate risk factors generated dynamically from user interaction). The CRCS 250 processes the data from different types of data sources to define an electronic mapping to represent a causal link between data elements for transition scenarios, modulators, elements and risks to data elements for geographic regions.

The server 100 manages risk factors for different types of risk.

FIG. 20 shows an example binomial scenario tree for macro risk factors. The system can generate multifactor stress scenarios on combinations of these factors for each horizon in the future that is of interest. This amounts to transition stress scenarios. The end result has properties under relatively mild assumptions. Namely, the very best and very worst scenario for each factor is contained in the scenario set. The output generates a “spanning set” of stress scenarios over time.

As noted herein, each macro risk factors can be comprised of multiple micro risk factors. The micro risk factors are random variables, and at any point in the future horizon they can be represented by uncertainty distributions. The individual macro factors can also be represented by uncertainty distributions. The server 100 (using e.g. processor 120) can derive each of the macro factor distributions from the (weighted) convolution of the micro risk factor distributions (of which they are comprised). The convolution is a method to aggregate the distributions representing the micro risk factors for a given macro risk factor. The input to the climate financial risk computation by the server 100 is the future uncertainty of micro risk factors that affect the entity in question, in every geographic location that is relevant to the entity and its physical and investment assets. The server 100 can derive these distributions with data collected the judgements of experts on each region. The data can be combined with the expert judgements embodied in the transition scenarios.

To obtain consistency across markets, and sectors within markets, the server 100 can use multi-factor scenario generator 180. The server 100 can use the individual factor distributions as input data and generates multifactor scenario (e.g. using multi-factor scenario generator 180) as outputs. In this way, the server 100 can use the same methodology across and within markets for multi-factor stress testing. FIG. 20 shows an example of multifactor scenarios (or a spanning set). The multifactor stress scenarios are combinations of the macro risk factors for each horizon in the future that is of interest. This amounts to transition stress scenarios. The end result has interesting properties. Namely, the very best and very worst scenario for each factor is contained in the scenario set, such that it may be considered a spanning set of stress scenarios over time.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the description, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The following discussion provides many example embodiments. Although each embodiment represents a single combination of inventive elements, other examples may include all possible combinations of the disclosed elements. Thus if one embodiment comprises elements A, B, and C, and a second embodiment comprises elements B and D, other remaining combinations of A, B, C, or D, may also be used.

The term “connected” or “coupled to” may include both direct coupling (in which two elements that are coupled to each other contact each other) and indirect coupling (in which at least one additional element is located between the two elements).

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements. The embodiments described herein are directed to electronic machines and methods implemented by electronic machines adapted for processing and transforming electromagnetic signals which represent various types of information. The embodiments described herein pervasively and integrally relate to machines, and their uses; and the embodiments described herein have no meaning or practical applicability outside their use with computer hardware, machines, and various hardware components. Substituting the physical hardware particularly configured to implement various acts for non-physical hardware, using mental steps for example, may substantially affect the way the embodiments work. Such computer hardware limitations are clearly essential elements of the embodiments described herein, and they cannot be omitted or substituted for mental means without having a material effect on the operation and structure of the embodiments described herein. The computer hardware is essential to implement the various embodiments described herein and is not merely used to perform steps expeditiously and in an efficient manner.

Embodiments relate to processes implements by a computing device having at least one processor, a data storage device (including volatile memory or non-volatile memory or other data storage elements or a combination thereof), and at least one communication interface. The computing device components may be connected in various ways including directly coupled, indirectly coupled via a network, and distributed over a wide geographic area and connected via a network (which may be referred to as “cloud computing”).

An example computing device includes at least one processor, memory, at least one I/O interface, and at least one network interface. A processor may be, for example, any type of microprocessor or microcontroller, a digital signal processing (DSP) processor, an integrated circuit, a field programmable gate array (FPGA), a reconfigurable processor, a programmable read-only memory (PROM), or any combination thereof. Memory may include a suitable combination of any type of computer memory that is located either internally or externally.

Each I/O interface enables computing device to interconnect with one or more input devices, such as a keyboard, mouse, camera, touch screen and a microphone, or with one or more output devices such as a display screen and a speaker. Each network interface enables computing device to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these.

Although the embodiments have been described in detail, it should be understood that various changes, substitutions and alterations can be made herein without departing from the scope as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

As can be understood, the examples described above and illustrated are intended to be exemplary only.

What is claimed is:

1. A computer system for computer models for risk factors and scenario generation comprising:
non-transitory memory storing a risk model comprising a causal graph of nodes for risk factors and a knowledge graph defining an extracted relationship of the nodes, each node storing a quantitative uncertainty value derived for a time horizon, the causal graph having edges connecting the nodes to create scenario paths for the risk model, the knowledge graph of the nodes defining a network structure with links between nodes;
a hardware processor with a communication path to the non-transitory memory to:
generate integrated risk data structures for a plurality of macro risk factors, wherein the integrated risk data structures map the plurality of macro risk factors to geographic space and time;
populate data in the memory by computing values for the plurality of macro risk factors for the time horizon using the integrated climate risk data structures, the values computed by a convolution of micro risk factor distributions to generate distribution measurements for the plurality of macro risk factors;
generate multifactor scenario sets using the distribution measurements for the plurality of macro risk factors and the scenario paths for the climate model to compute the likelihood of different scenario paths for the climate model, the multifactor scenario sets representing combinations of the macro risk factors over a time horizon;
generate risk metrics using the multifactor scenario sets and the knowledge graph;
transmit at least a portion of the risk metrics and the multifactor scenario sets in response to queries by a client application;
store the integrated risk data structures and the multifactor scenario sets in the non-transitory memory; and
a computer device with a hardware processor having the client application to transmit queries to the hardware processor and an interface to generate visual elements at least in part corresponding to the multifactor scenario sets and the risk metrics received in response to the queries.

2. The system of claim 1 wherein the hardware processor computes the convolution of the micro risk factor distributions using simulations, wherein the micro risk factor distributions correspond to a plurality of micro variables for the macro risk factors.

3. The system of claim 2 wherein the simulation is based on a Monte Carlo simulation.

4. The system of claim 1, wherein each macro risk factor comprises of a set of micro risk factors having corresponding micro risk factor distributions over time, wherein the processor computes a distribution measurement for the respective of macro risk factor using a convolution of the micro risk factor distributions.

5. The system of claim 1, wherein the plurality of macro risk factors comprise a policy macro risk factor, an economy macro risk factor, a carbon macro risk factor, a physical macro risk factor, and a social macro risk factor.

6. The system of claim 1, wherein the interface has a visualization corresponding to a rating for an asset, wherein the visualization depicts a target value and the multifactor distribution of climate stressors on the asset.

7. The system of claim 1, wherein the interface has a visualization depicting climate risk ratings of a financial impact of a stress scenario on an asset.

8. The system of claim 1 wherein the processor generates forward looking uncertainty distributions for each of the macro risk factors, in each geography, at each time horizon.

9. The system of claim 1 wherein the processor generates a transition scenario for a macro risk factor as a selection of the macro risk factor in a given location repeated over each time period or horizon.

10. The system of claim 1 wherein each node stores the quantitative uncertainty value derived by a forward-probability distribution of possible values for the time horizon, wherein the hardware processor populates the causal graph of nodes by computing the forward-probability distribution of possible values for the time horizon.

11. The system of claim 1 wherein the hardware processor populates the causal graph of nodes using extremes values of the distributions and a weight of the distributions above and below accepted values.

12. The system of claim 1 wherein the hardware processor generates the causal graph having forward edges connecting the nodes to create the scenario paths for the risk model.

13. The system of claim 1 wherein the hardware processor identifies macro risk factors in response to a request and generates the causal graph of nodes using the identified macro risk factors and dependencies between the risk factors.

14. The system of claim 1 wherein the hardware processor continuously populates the causal graph of nodes by re-computing the probability distribution of possible values for the risk factor at different points in time by continuously collecting data using the machine learning system and the expert judgement system.

15. The system of claim 1 wherein the hardware processor computes the forward-probability distribution of possible values for the risk factor for the time horizon to extract upward and downward extreme values, and likelihoods of upward and downward movement from the forward-probability distribution.

16. The system of claim 1 wherein the hardware processor wherein the hardware processor filters outlier data using the structured expert judgement system before computing the forward-probability distribution.

17. The system of claim 1 wherein the hardware processor populates the causal graph of nodes by computing the probability distribution of possible values for different points in time using machine learning and structured expert judgement data to collect the possible values representing estimates of future uncertain values.

18. The system of claim 1 wherein the hardware processor generates the multifactor scenario sets using the scenario paths for the risk model and generates scenario values using the probability distribution of possible values for the risk factors.

19. A computer method for computer models for risk factors and scenario generation to query and aggregate impact, cost, magnitude and probability of risk for different geographic locations, the method comprising:
storing, in non-transitory memory, a risk model comprising a causal graph of nodes and a knowledge graph defining an extracted relationship of the nodes, each node storing a quantitative uncertainty value derived for the risk factor for a time horizon, the causal graph having edges connecting the nodes to create scenario paths for the risk model, the knowledge graph of the nodes defining a network structure of the risk factors with links between nodes having weight;
generating, using a hardware processor with a communication path to the non-transitory memory, integrated, codified and machine-accessible risk data structures for a plurality of macro risk factors, wherein the integrated risk data structures map the plurality of macro risk factors to geographic space and time;
populating data in the memory by computing values for the plurality of macro risk factors over the time horizon using the integrated climate risk data structures, the values computed by a convolution of micro risk factor distributions to generate distribution measurements for the plurality of macro risk factors;
generating multifactor scenario sets using the distribution measurements for the plurality of macro risk factors and the scenario paths for the climate model to compute the likelihood of different scenario paths for the climate model, the multifactor scenario sets representing combinations of the macro risk factors over a time horizon;
generating risk metrics using the multifactor scenario sets and the knowledge graph;
transmitting, by the hardware processor, at least a portion of the risk metrics and the multifactor scenario sets in response to queries by a client application; and
storing the integrated risk data structures and the multifactor scenario sets in the non-transitory memory.

20. The method of claim 19 wherein further comprising the convolution of the micro risk factor distributions using simulations, wherein the micro risk factor distributions correspond to a plurality of micro variables for the macro risk factors.

21. The method of claim 20 further comprising using a Monte Carlo simulation.

22. The method of claim 19 wherein each macro risk factor comprises of a set of micro risk factors having corresponding micro risk factor distributions over time, wherein the method further comprises computing a distribution measurement for the respective of macro risk factor using a convolution of the micro risk factor distributions.

23. The method of claim 19 wherein the plurality of macro risk factors comprise a policy macro risk factor, an economy macro risk factor, a carbon macro risk factor, a physical macro risk factor, and a social macro risk factor.

24. The method of claim 19 further comprising updating the interface with a visualization corresponding to a rating for an asset, wherein the visualization depicts a target value and the multifactor distribution of climate stressors on the asset.

25. The method of claim 19 further comprising updating the interface with a visualization depicting climate risk ratings of a financial impact of a stress scenario on an asset.

26. The method of claim 19 further comprising generating forward looking uncertainty distributions for each of the macro risk factors, in each geography, at each time horizon.

27. The method of claim 19 further comprising generating a transition scenario for a macro risk factor as a selection of the macro risk factor in a given location repeated over each time period or horizon.

28. A computer method for measuring climate financial risk for different geographic locations, the method comprising:
defining a plurality of macro risk factors, the risk factors comprising different types of risk factors that affect a plurality of assets at each geographic location of a plurality geographic locations, the each of the plurality of assets having a corresponding asset type and geographic location;
deriving factor uncertainty at each relevant future horizon, for each asset, in each location, worldwide, wherein the factor uncertainty is expressed as a distribution;
evaluating and rating the exposure of the physical asset;
generating forward-looking multifactor stress scenarios to stress test each asset at each time horizon;
computing a financial impact of all relevant multifactor stress scenarios on the asset; and
generating, at an interface on a display device of a computer, visualizations corresponding to the financial impact the relevant multifactor stress scenarios on the asset.

29. A computer system for measuring climate financial risk, the method comprising:
non-transitory memory storing a risk model;
a hardware processor with a communication path to the non-transitory memory to:
define a plurality of macro risk factors, the risk factors comprising different types of risk factors that affect a plurality of assets at each geographic location of a plurality geographic locations, the each of the plurality of assets having a corresponding asset type and geographic location;
derive factor uncertainty at each relevant future horizon, for each asset, in each location, worldwide, wherein the factor uncertainty is expressed as a distribution;
evaluate and rate the exposure of the physical asset;
generate forward-looking multifactor stress scenarios to stress test each asset at each time horizon;
compute a financial impact of all relevant multifactor stress scenarios on the asset; and
generate, at an interface on a display device of a computer, visualizations corresponding to the financial impact the relevant multifactor stress scenarios on the asset.

30. Non-transitory computer readable medium storing instructions for measuring climate financial risk for different geographic locations, which when executed by a hardware processor cause the processor to implement operations comprising:
storing, in non-transitory memory, a risk model comprising a causal graph of nodes and a knowledge graph defining an extracted relationship of the nodes, each node storing a quantitative uncertainty value derived for the risk factor for a time horizon, the causal graph having edges connecting the nodes to create scenario paths for the risk model, the knowledge graph of the nodes defining a network structure of the risk factors with links between nodes having weight;
generating, using a hardware processor with a communication path to the non-transitory memory, integrated, codified and machine-accessible risk data structures for a plurality of macro risk factors, wherein the integrated risk data structures map the plurality of macro risk factors to geographic space and time;
populating data in the memory by computing values for the plurality of macro risk factors over the time horizon using the integrated climate risk data structures, the values computed by a convolution of micro risk factor distributions to generate distribution measurements for the plurality of macro risk factors;
generating multifactor scenario sets using the distribution measurements for the plurality of macro risk factors and the scenario paths for the climate model to compute the likelihood of different scenario paths for the climate model, the multifactor scenario sets representing combinations of the macro risk factors over a time horizon;
generating risk metrics using the multifactor scenario sets and the knowledge graph;
transmitting, by the hardware processor, at least a portion of the risk metrics and the multifactor scenario sets in response to queries by a client application; and
storing the integrated risk data structures and the multifactor scenario sets in the non-transitory memory.

31. Non-transitory computer readable medium storing instructions for computer models for risk factors and scenario generation to query and aggregate impact, cost, magnitude and probability of risk for different geographic locations, which when executed by a hardware processor cause the processor to implement operations comprising:
defining a plurality of macro risk factors, the risk factors comprising different types of risk factors that affect a plurality of assets at each geographic location of a plurality geographic locations, the each of the plurality of assets having a corresponding asset type and geographic location;
deriving factor uncertainty at each relevant future horizon, for each asset, in each location, worldwide, wherein the factor uncertainty is expressed as a distribution;
evaluating and rating the exposure of the physical asset;
generating forward-looking multifactor stress scenarios to stress test each asset at each time horizon;
computing a financial impact of all relevant multifactor stress scenarios on the asset; and
generating, at an interface on a display device of a computer, visualizations corresponding to the financial impact the relevant multifactor stress scenarios on the asset.
